(19) United States
(12) Patent Application Publication
(10) Pub. No.: US 2025/0284717 A1
(43) Pub. Date: Sep. 11, 2025

(54) SYSTEM AND METHODS FOR INTEGRATING SPORTS DATA AND MACHINE LEARNING TECHNIQUES TO GENERATE RESPONSES TO USER QUERIES

(71) Applicant: STATS LLC, Chicago, IL (US)

(72) Inventors: James COVERDALE, Limerick (IE); Claudio BRIDI, Prague (CZ); Matjaz ALES, Kungota (SI); Serghei VELENCIUC, Prague (CZ); Christian Marko, Graz (AT); Shaun McMURRAY, Graz (AT); Karl FERK, Graz (AT); Damian CZARNECKI, Katowice (PL); Stefano ANTONELLO, San Martino di Lupari (IT); Robert SEIDL, Munich (DE)

(73) Assignee: Stats LLC, Chicago, IL (US)

(21) Appl. No.: 19/071,255

(22) Filed: Mar. 5, 2025

Related U.S. Application Data
(60) Provisional application No. 63/561,834, filed on Mar. 6, 2024.

(51) Int. Cl. G06F 16/3329; G06F 16/783; G06F 16/9532

(52) U.S. Cl. CPC G06F 16/33295; G06F 16/783; G06F 16/9532

(57) ABSTRACT

A method for generating multi-modal response to a query using a generative machine learning model, the method including: receiving, from a client device, a query data object related to a sporting event; providing the query data object and a first prompt to a machine learning system; receiving, from the machine learning system, a function, from a set of functions, associated with the query data object; receiving, from the machine learning system, an output format; providing a data source mapped to the function, the query data object, and a second prompt to the machine learning system, receiving, from the machine learning system, a response to the query data object, wherein the response is formatted based on the output format; and outputting the response to one or more users.

### CROSS-REFERENCE TO RELATED APPLICATION(S)

This application claims the benefit of priority to U.S. Provisional Patent Application No. 63/561,834, filed Mar. 6, 2024, the entirety of which is incorporated by reference herein.

### TECHNICAL FIELD

Various aspects of the present disclosure relate generally to machine learning techniques for sports applications. In particular various aspects relate to system and methods for integrating sports data and machine learning techniques to generate responses to user queries.

### BACKGROUND

With the rising popularity of sports, there is an increased desire for customized sports content. For example, users may want to receive answers to questions, receive graphics/videos, or odds relative to sporting events. Further, it may be challenging for users to receive sports content in a preferred format. Machine learning techniques can be utilized to generate sports content, however, may lack access to proper data to most appropriately determine relevant sports content.

Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, In some aspects, the techniques described herein relate to a method for generating multi-modal response to a query using a generative machine learning model, the method including: receiving, from a client device, a query data object related to a sporting event; providing the query data object and a first prompt to a machine learning system; receiving, from the machine learning system, a function, from a set of functions, associated with the query data object; receiving, from the machine learning system, an output format; providing a data source mapped to the function, the query data object, and a second prompt to the machine learning system, receiving, from the machine learning system, a response to the query data object, wherein the response is formatted based on the output format; and outputting the response to one or more users.

In some aspects, the techniques described herein relate to a method, wherein the query data object is a query related to a player, team, graphic, video, prediction, and/or odds of the sporting event.

In some aspects, the techniques described herein relate to a method, wherein the first prompt includes: the set of functions; a description of each function of the set of functions; and a machine readable request instructing the machine learning system to associate the query data object with a function from the set of functions based on the description of each function.

In some aspects, the techniques described herein relate to a method, wherein the first prompt includes: a set of output formats; a description of each output format; and a machine readable request instructions the machine learning system to associate the query data object with the output format from the set of output formats.

In some aspects, the techniques described herein relate to a method, wherein the set of output formats include graphics, audio, images, videos, image overlays, or a textual response.

In some aspects, the techniques described herein relate to a method, wherein the set of functions are each mapped to respective data sources and types of information.

In some aspects, the techniques described herein relate to a method, wherein the set of functions include: a current match state function; a current player state function; a historical team function; a historical player function; a graphic function; a video function; a generation function; a prediction function; an odds function; a other sports function; or a non-sports question.

In some aspects, the techniques described herein relate to a method, wherein if the received function, from the set of functions, is the current match state function or the current player state function, then the second prompt includes: a machine readable request instructing the machine learning system to answer the query data object based on the current match state function or the current player state function.

In some aspects, the techniques described herein relate to a method wherein if the received function from the set of functions, is the historical team function, the historical player function, or other sports function, method further includes: accessing a database; requesting historical information from the database; obtaining the historical information in a structured query language (SQL) Query; and updating the second prompt to include a machine readable request to adapt the SQL query to extract data that responds to the query data object and form a response to the query data object.

In some aspects, the techniques described herein relate to a method, wherein if the received function from the set of functions, is a non-sports question, then the method further includes: performing a search for the query data object through an internet browser; saving results from the internet browser; and updating the second prompt to include a machine readable request to respond to the query data object and form a textual response based on the results from the internet browser.

In some aspects, the techniques described herein relate to a method, wherein if the received function from the set of functions, is the graphic function, then the method further includes: a machine readable request instructing the machine learning system to provide an image related to the query data object based on the graphic function.

In some aspects, the techniques described herein relate to a method, wherein if the received function from the set of functions, is the generation function, then the method further includes: sending a machine readable request instructing a second machine learning system to provide a response to the query data object based on the generation function; and receiving the response from the second machine learning system.

In some aspects, the techniques described herein relate to a method, wherein the query data object related to a sporting event includes preferences for a language, topic, style, tone, or format, the method further comprising providing the preferences to the machine learning system.

In some aspects, the techniques described herein relate to a system for generating textual answer to a query using a generative machine learning model, the system including: a memory configured to store processor-readable instructions; and a processor operatively connected to the memory, and configured to execute the instructions to perform operations comprising: receiving, from a client device, a query data object related to a sporting event; providing the query data object and a first prompt to a machine learning system; receiving, from the machine learning system, a function, from a set of functions, associated with the query data object; receiving, from the machine learning system, an output format; providing a data source mapped to the function, the query data object, and a second prompt to the machine learning system, receiving, from the machine learning system, a response to the query data object, wherein the response is formatted based on the output format; and outputting the response to one or more users.

In some aspects, the techniques described herein relate to a system, wherein the query data object is a query related to a player, team, graphic, video, prediction, and/or odds of the sporting event.

In some aspects, the techniques described herein relate to a system, wherein the first prompt includes: the set of functions; a description of each function of the set of functions; and a machine readable request instructing the machine learning system to associate the query data object with a function from the set of functions based on the description of each function.

In some aspects, the techniques described herein relate to a system, wherein the first prompt includes: a set of output formats; a description of each output format; and a machine readable request instructions the machine learning system to associate the query data object with the output format from the set of output formats.

In some aspects, the techniques described herein relate to a non-transitory computer readable medium configured to store processor-readable instructions, wherein when executed by a processor, the instructions perform operations including: receiving, from a client device, a query data object related to a sporting event; providing the query data object and a first prompt to a machine learning system; receiving, from the machine learning system, a function, from a set of functions, associated with the query data object; receiving, from the machine learning system, an output format; providing a data source mapped to the function, the query data object, and a second prompt to the machine learning system, receiving, from the machine learning system, a response to the query data object, wherein the response is formatted based on the output format; and outputting the response to one or more users.

In some aspects, the techniques described herein relate to a non-transitory computer readable medium, wherein the query data object is a query related to a player, team, graphic, video, prediction, and/or odds of the sporting event.

In some aspects, the techniques described herein relate to a non-transitory computer readable medium, wherein the first prompt includes: the set of functions; a description of each function of the set of functions; and a machine readable request instructing the machine learning system to associate the query data object with a function from the set of functions based on the description of each function.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to one or more embodiments.

FIG. 2A is a block diagram of a response generation environment, according to one or more embodiments.

FIG. 2B is a block diagram of another response generation environment, according to one or more embodiments.

FIG. 3 is a flow diagram of an exemplary method for using a machine learning model to generate a response to a received query, according to one or more embodiments.

FIG. 4 is a flow diagram of an exemplary method for using machine learning models to generate textual answer prediction in response to a historical sports question, according to one or more embodiments.

FIG. 5 is a flow diagram of an exemplary method for using machine learning models to generate answer predictions in response to a non-sports question, according to one or more embodiments.

FIG. 6 is an exemplary user interface for a response generation environment, according to one or more embodiments.

FIG. 7 is an exemplary block diagram of exemplary user query templates displayed on a user interface, according to one or more embodiments.

FIG. 8A-8D are exemplary generated data formatted responses, according to one or more embodiments.

FIG. 9A-9D are exemplary generated prediction formatted response, according to one or more embodiments.

FIG. 10A-10B are exemplary generated player metric formatted response, according to one or more embodiments.

FIG. 11A-11C are exemplary generated editorial formatted response, according to one or more embodiments.

FIG. 12A-12C are exemplary generated widget formatted responses, according to one or more embodiments.

FIG. 13A-13B are exemplary generated graphic formatted response, according to one or more embodiments.

FIG. 14A-14C are exemplary generated video formatted response, according to one or more embodiments.

FIG. 15A-15C are exemplary generated odds formatted response, according to one or more embodiments.

FIG. 16 depicts a flow diagram for training a machine-learning model, according to example embodiments.

FIG. 17A is a block diagram illustrating a computing device, according to example embodiments.

FIG. 17B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION OF ASPECTS

Various aspects of the present disclosure relate generally to machine learning for sports applications, in particular various aspects relate to system and methods for integrating sports data and machine learning techniques to generate responses to user queries.

An individual may have specific queries related to a sporting event. Traditional search engines may be unable to answer sporting event specific questions (e.g., such as how many goals did player X score against team Y in the previous three matches). Traditional machine learning systems may not have access to the types of sporting data required to answer user specific queries.

Further, it may be challenging for a user to receive a response in a desired output format. Traditional systems may only generate responses in a particular format.

One or more embodiments disclosed herein may include a system configured to associate a particular user query with a particular function type, where each function is associated with a particular data source (e.g., in-game information, historical information, etc.). For example, a function may be a link to a particular data source. The system may, upon determining the function type, feed a user generated query along with the particular data source associated with the function type and associated data source to a machine learning system. The machine learning system may, upon accessing the related data source, generate one or more multimodal responses (e.g., text, graphics, video, etc.) to respond to the user query, based on the related data source. For example, generated responses may focus on data, predictions, graphics, widgets, videos, and/or the like. Generated response may incorporate data (e.g., team and player statistics), predictions (match prediction, season simulation, and/or team and player propositions), player physical metrics (e.g., distances ran, sprint speed, high intensity effort (“HIE”) intervals, etc.), editors (natural language generated player bios, match previews, and/or recaps), widgets (goal replays, match statistics, formations, long-weighted passes (“LW”)), analytic graphics (e.g., player radar, carry plots), videos (e.g., press conferences, match preview/recaps), or odds (e.g., statistical odds for match outcome or events occurring during and/or before a sporting event).

One or more embodiments disclosed herein may include systems and methods for generating responses for queries related to a variety of sports including, but not limited to, soccer, tennis, football, basketball, cricket, wrestling, baseball, hockey, rugby, team sports, individual sports, etc. The system may further be linked with one or more sources to provide both preset and live odds for the occurrence of particular outcomes and actions during a sporting event. The system may be configured to generate responses in multiple languages. In some examples, the model incorporated herein may track user conversations to retrain and improve generated responses. For example, a user may provide feedback on a received generated response and such feedback may be used to train or re-train one or more machine learning models disclosed herein.

While soccer and various aspects relating to soccer (e.g., a predicted total number of passes by a team during a game) are generally described in the present aspects as illustrative examples, the present aspects are not limited to such examples. For example, the present aspects can be implemented for other sports or activities, such as American football, basketball, baseball, rugby, hockey, cricket, golf, tennis, team sports, individual sports, and so forth.

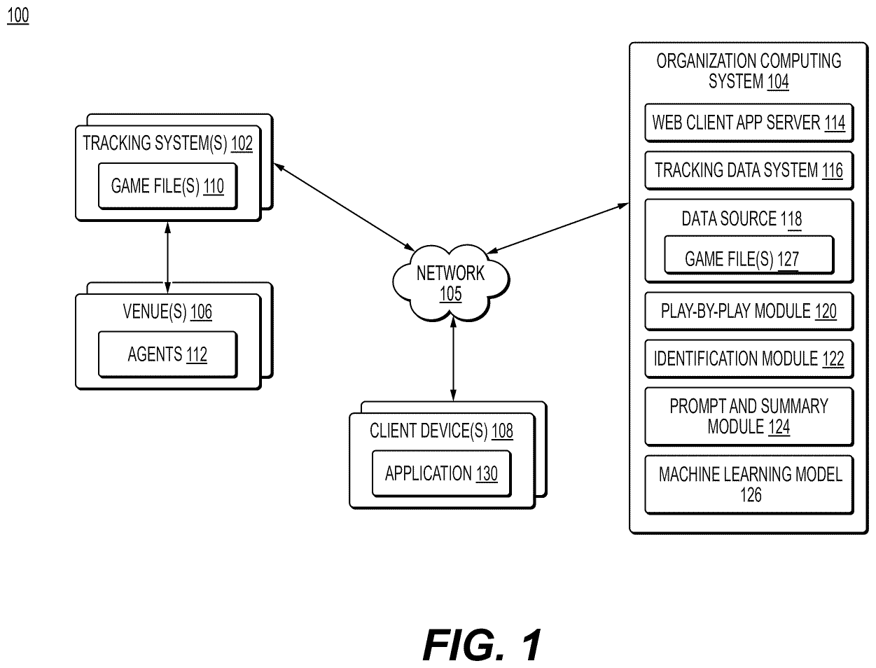

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105. The computing environment 100 may be configured to generate one or more multi-modal responses to a user specific query based upon a received data source related to the user query.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication (e.g., electronic communication, wireless communication, wired communication, etc.) with venue 106 and/or components thereof. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, game file 110 may further be augmented with other event information corresponding to event data, such as, but not limited to, game event information (pass, made shot, turnover, etc.) and context information (current score, time remaining, etc.). Event data may be automatically identified using a machine learning trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data source 118, discussed further herein.

Organization computing system 104 may be configured to generate responses to user queries. Organization computing system 104 may include a web client application server 114, tracking data system 116, data source 118, a play-by-play module 120, an identification module 122, prompt and summary module 124, and a machine learning model 126. Each of tracking data system 116, play-by-play module 120, identification module 122, prompt and summary module 124, and a machine learning model 126 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

The computing system 104 may include a user interface accessible by a client device 108. The computing system 104 may be built on a frontend (e.g., a JavaScript or React front end) with a programming backend (e.g., a python backend) and may implement Amazon Web Services Bedrock and LangChain for Large Language Modules (“LLM”) integration (e.g., Claude3) with Retrieval-Augmented Generation (“RAG”) to connect it to internal content sources (Application programming interfaces (APIs)).

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such process, organization computing system 104 may go beyond the generation of tracking data from broadcast video data. Instead, to provide descriptive analytics, as well as a useful feature representation for the clipping module 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influence score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

The environment 100 may further include an identification module 122, a prompt and summary module 124, and a machine learning model 126. In some cases, machine learning model 126 may be remotely hosted, for example on a remote server. The machine learning model 126 may include one or more machine learning models such as those models discussed herein and may include one or more generative machine learning models.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

The identification module 122 I may be configured to receive user queries (e.g., from a client device 108) and prepare a prompt for a machine learning model (e.g., the machine learning model 126). The prompt may request for the machine learning model to associate the received user query with a particular data source (e.g., from data source 118). The prompt may include a list of relevant data sources with descriptions of the respective sources. The data sources may be accessible locally or externally through an Application Programming Interface (API). For example, an API call may be made to an external or internal data source based on the prompt, such that the API call may result in receiving requested information from the data source.

The machine learning model 126 may be configured to receive a prompt from the identification module 122 and to identify an associated data source or function. The identified data source or function may be a set of data most related to a user query. For example, identification module 122 may input the user query into an LLM which may output results (e.g., structured data, pointers, features, and/or the like) associated with the query. The results may be mapped to attributes associated with the data sources and/or functions. For example, the mapping may identify correlation scores for each of the data sources and/or functions such that a correlation score identifies a semantic distance between the results and each respective data source/function. The data source and/or function with the highest correlation score may be mapped as the data source or function most related to the user query,

The prompt and summary module 124 may be configured to prepare an input for a machine learning model (e.g., the machine learning model 126). The input may include the user query, the mapped data source previously identified, a second prompt requesting the machine learning model to generate a response based on the user query and mapped data source. The one or more machine learning models may then be configured to generate a response to an initial query based on the initial query, the mapped data source previously identified, and/or the second prompt requesting the machine learning model to generate a response.

The prompt and summary module 124 may further include one or more AI Agent and Tools. Each of the one or more AI Agent and Tools may be associated with a particular data source (e.g., graphics, videos, etc.), and may be configured to utilize an API to access relevant data (e.g., via API calls). The one or more AI Agent and Tools may be configured to output embedded code, graphics URLs with specific parameters, and/or URLs to videos. Each AI Agent and tool associated with a particular external source may include a specific “generation function” allowing the AI Agent and Tool to retrieve relevant information to generate an output. The outputs of an AI Agent and Tool may include a URL to a graphic of video, embedded code for a widget or text summary of editorial fact-based information, or a summary/interpretation of a dataset like the predictions. The AI Agent and Tools may allow for more concise and relevant data to be extracted and sent to the machine learning model 126 for processing. For example, a given AI Agent and Tools component may be trained using a data set specific to or relevant to a given data source or data source type. Accordingly, each AI agent and Tools component may be configured to provide an output that is tailored to its respective data source or data source type, based on its training.

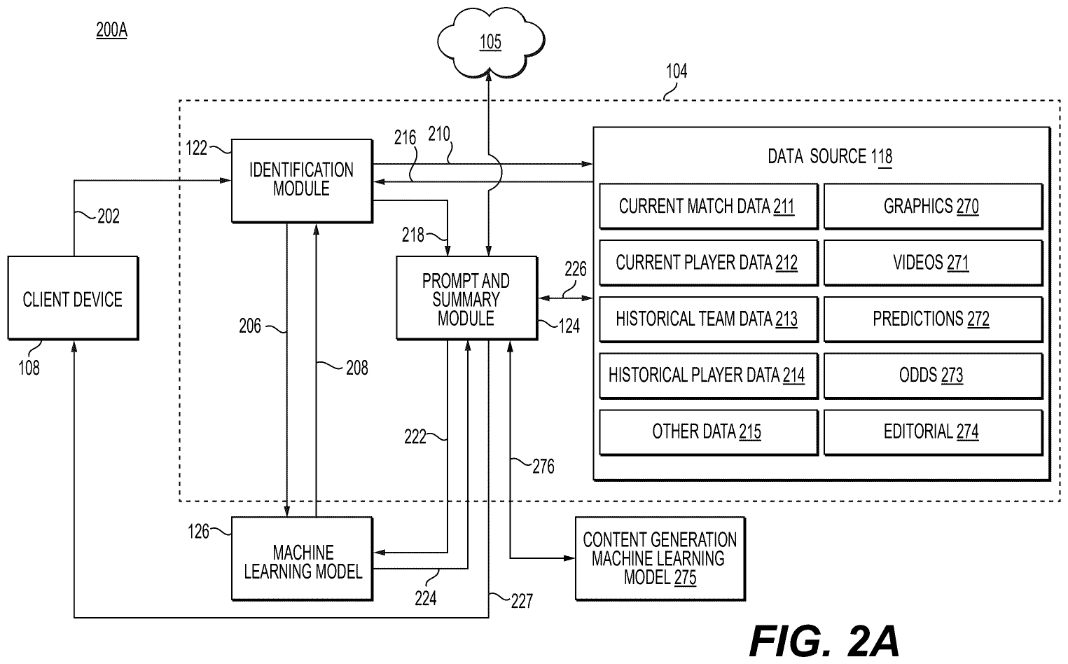

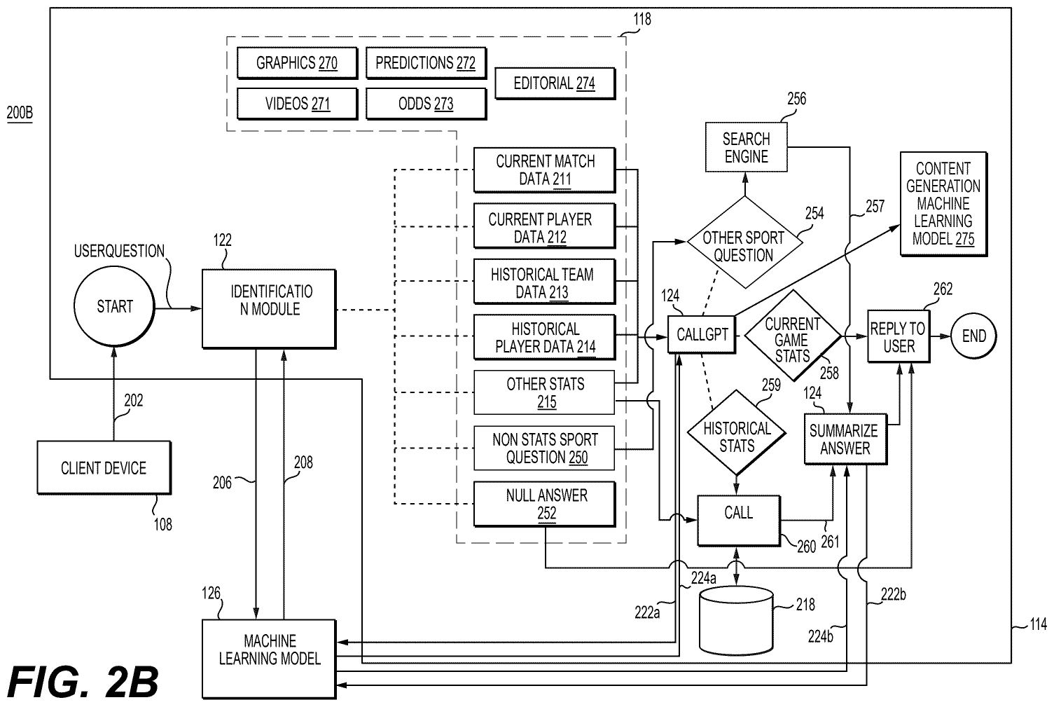

Accordingly, the identification module 122, the prompt and summary module 124, and the machine learning model 126 may work in conjunction to generate responses to user queries. These components may be described in further detail below in FIG. 2A and FIG. 2B.

Data source 118 may be configured to store one or more game files 127. Each game file 127 may include video data of a given match. For example, the video data may correspond to a plurality of video frames captured by tracking system 102, the tracking data derived from the broadcast video as generated by tracking data system 116, play-by-play data, enriched data, and/or padded training data. Game files 127 may be based, for example, on game files 110 as discussed herein. Game files 127 may be in a different format than game files 110. For example, a first format of game files 110 or a subset thereof may be transformed into a second format of game files 127. The transformation may be performed automatically based on the type and/or content of the first format and the type and/or content of the second format. As described in greater detail below, the data source 118 may further be configured to store clipping rules and generated video clips in a video repository.

Data source 118 may be configured to store different kinds of data (e.g., in one or more formats). In an example, data source 118 can store raw tracking data received from tracking system 102. The data source 118 can include historical game data (from both the players and teams), live data (form both the players and teams), features, and/or predictions. The historical game data can include historical team and player data for one or more sporting events. Live data can include data received from tracking system 102, e.g., in real time (e.g., within approximately 30 seconds, within 1 minute, within 5 minutes, within 10 minutes, and/or the like). The data store may further include statistical odds related to sporting events, graphics, videos, predictions, and/or editorials related to sporting events.

Data source 118 can store one or more kinds of data in database records, linked lists, arrays, or other data structures. In some cases, data source 118 can be updated with new data (e.g., live data or updated ratings) and/or requestor preferences, as appropriate. In some cases, a request to the data source 118 can be in the form of an SQL query. In some cases, the response from data source 118 can be a JSON response. The data source 118 may have components and data stored locally in computing system 104. The data source 118 may further include data (e.g., graphics 270, videos 271) stored in separate servers and accessed through an application programming interface (“API”).

The data source 118 may include current match data, current player data, historical team information (e.g., statistics), historical player information, graphics, videos, predictions, odds, and/or editorials. This data may be stored in separate formats that may be accessed by particular functions. Current match data may include event data for a particular sporting event (e.g., a live sporting event), such as, but not limited to, game event information (pass, made shot, turnover, etc.) and context information (current score, time remaining, etc.). Current player data may include live player statistics for a particular sporting event (e.g., a live sporting event) such as time played, passes performed, shots taken, goals scored, assists performed, etc. This may also include physical metrics such as distances, sprints, HIE, etc.

Historical team statistics may include a particular team's record, match history for each team, home and away games, attendance, date of games, score of games. Historical player information may include goals, passes, assist, yellow card, red card, and expected goals per player from past games.

Graphics may include images from a sporting event (e.g., images from highlights or key events in a sporting event). Graphics may further include player radar and carry plots. Videos may include press conferences, match previews and recaps, match highlights, etc. Predictions may include mat predictions, season simulations, and team and player propositions. Odds may include predicted winners, predicted over/under of scores, and other statistical odds related to the sporting event. Editorials may include player biographies, match previews, and/or match recaps.

For example, the current match data (e.g., including current player data) may be available at a local storage level in the data source 118. The historical team statistics and historical team player information may be stored in a relational database. The relational database may, for example, be accessed by a structured query language (SQL) query. Accordingly, for example, current match data may be stored at a first location in a first format and historical data may be stored at a different location than the current match data, in a second format.

Client device(s) 108 may be in communication with organization computing system 104 via network 105. Client device(s) 108 may be operated by a user or system component(s). For example, client device(s) 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to receive a generated video clip from the computing system 104. The content that is displayed to client device 108 may be transmitted from web client application server 114 to client device 108, and subsequently processed by application 130 for display through a graphical user interface (GUI) of client device 108.

FIG. 2A is a block diagram of a response generation environment 200A, according to one or more embodiments. The environment 200A may be configured to receive input queries from a user and to determine multi-modal responses as answers based upon identified relevant data sources. The environment 200A may include client device 108, network 105, and a computing system 104. The computing system 104 may further include an identification module 122, a prompt and summary module 124, machine learning model 126, and a data source 118.

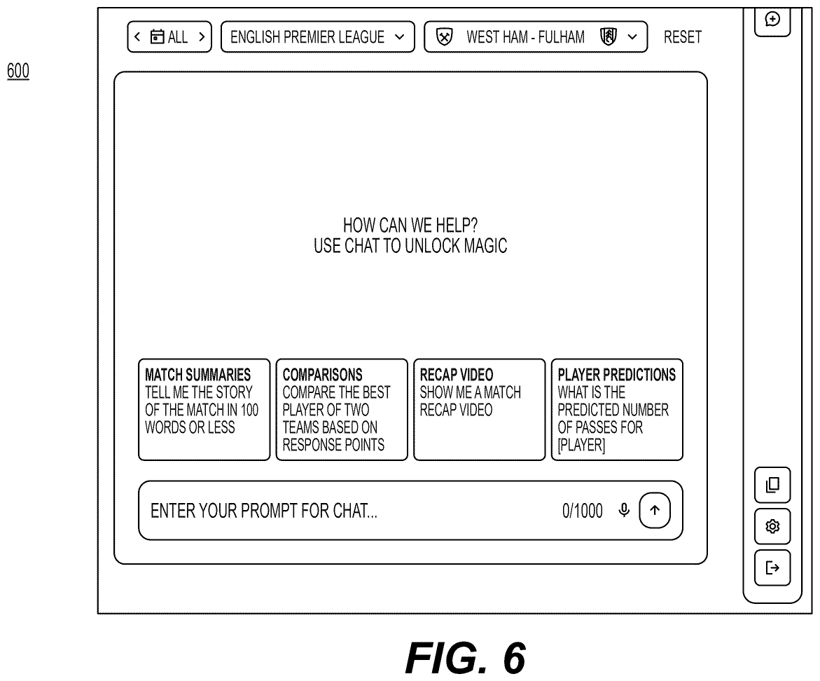

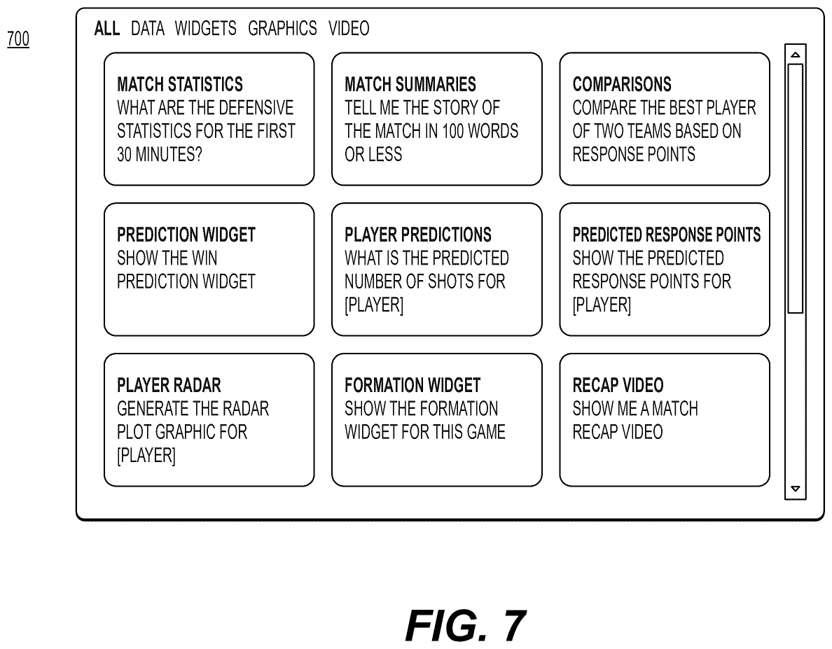

The client device 108 may be configured to receive a user query data object 202 (e.g., from a user, based on a user profile, etc.). An exemplary user interface of the client device 108 is shown in FIG. 6 and FIG. 7 discussed below. The user interface may include a text box that may receive typed inquiries from one or more users. In some examples, the client device may have access to a template library of set questions that may be asked of the system described herein. It will be understood that users may further input data queries via other formats than a text box such as audio input, video input, gestures, etc. In some examples, the other additional inputs may be translated to text by the computing system 104. For simplicity, text inputs are discussed herein but any input form the client device 108 may be received by the computing system 104.

The user query data object 202 can include a textual question relating to a sporting event. The query data object may relate to a current, future, or past sporting event. The query data object 202 may relate to either a player, team, or league as a whole. In some cases, the user query data object 202 can include optional requestor preferences, such as a desired tone, style, length, and/or format for the requested response. For example, a request may include specified tone of a casual type and a length of approximately 100 words. In another example, the requested response may designate the output format (e.g., as an image, video, or text). An example user query data object 202 received by the client device 108 may, for example be, “how many goals did player X score in his past five games vs team Y.”

The identification module 122 may be configured to receive a user query data object 202 from a client device. The identification module 122 may further have access to multiple of data source/functions (e.g., current match data 211, current player data 212, historical team data 213, historical player data 214, other data 215, graphics 270, videos 271, predictions 272, odds 273, and/or editorials 274). In response to the user query data object 202 and/or set of data/functions, the identification module 122 may be configured to provide a prompt 206 to the machine learning model 126 requesting a particular data source/function(s) be associated with the received query data object 202. For example, the prompt may include instructions readable by a machine learning system. The identification module 122 may be configured to prepare a prompt 206 that includes the received query data object 202, a set of functions/data sources, a description corresponding to each function/data source, and/or instructions for a machine learning system to associate the query data object 202 with one of the set of functions based on the description of each function. The first prompt may further include a set of output formats, descriptions of each output format, and a machine-readable request instructing the machine learning system to associate the query data object with the output format from the set of output formats. This first prompt may be a predefined prompt that is saved within the identification module 122. Example output formats include text, images, videos, and/or widgets. A widget may refer to an interactive user interface. Exemplary functions for the prompt 206 include:

```
  {
    “name”: “match_details_queries”,
    “description”: “Answer to current match related details. Useful to answer to user
questions about the game and contestants. Can create a brief summary of the game”,
    “parameters”: {
      “type”: “object”,
      “properties”: { }
    },
    “function_call”: “auto”
  },
  {
    “name”: “player_stats_queries”,
    “description”: “Answer to player related in current game. Useful to answer
questions about how players performed in the game.”,
    “parameters”: {
      “type”: “object”,
      “properties”: { }
    },
    “function_call”: “auto”
  },
  {
    “name”: “game_team_history_query”,
    “description”: “will give answers for historical/previous encounters between teams.
can provide scores, attendence, competision. can only deal with individual team game
history and team statistics and performance.”,
    “parameters”: {
      “type”: “object”,
      “properties”: { }
    },
    “function_call”: “auto”
  },
  {
    “name”: “player_historical_stats”,
    “description”: “Answer to player statistics in previous games. Can provide data
about goals, passes, assists, clean sheets”,
    “parameters”: {
      “type”: “object”,
      “properties”: { }
    },
    “function_call”: “auto”
  }
]
```

A machine learning model 126 may receive the prompt 206 from the identification module 122. The machine learning model 126 may be configured to identify an associated data source or function(s) that may be referred to as a function result 208. The function result 208 may be saved and output to the identification module 122. Accordingly, machine learning model 126 may be provided, as inputs, query data object 202 (e.g., including a question or query submitted by a user), a prompt, and/or a set of data sources/functions. Machine learning model 126 may output, based on the inputs, function result 208 which may identify a data set and/or functions that may be used to respond to the user query data object 202 (e.g., to provide a response to the user query).

The machine learning model 126 may determine the function result 208 by comparing descriptions of respective data sources with the user query data object 202, where the description of the respective data sources is included in the first prompt received from the identification module 122. The machine learning model 126 may assign a correlation score for each of the data sources and/or functions. For example, the mapping may identify correlation scores for each of the data sources and/or functions such that a correlation score identifies a semantic distance between the results and each respective data source/function. The data source and/or function with the highest correlation score may be mapped as the data source or function most related to the user query. In some examples, the machine learning model 126 may identify multiple relevant sources. In this scenario, all correlation scores for respective data sources higher than a threshold value may be deemed relevant and included in the function result 208.

By receiving the identified data set and/or functions from the machine learning model 126, a subset of all available data sets and/or functions may be identified for responding to a user query. Accordingly, in accordance with this technique, the time and/or computational resources to generate a response to the user query may be expedited by limiting the data sets and/or functions used to generate a response to the query. Further, targeted responses to the query may be generated by only using applicable data sets and/or functions, as output by the machine learning model 126.

The identification module 122 may receive the function result 208 and associate the function result 208 with a received data source 216 from the data source 118. The identification module 122 may be configured to send a request 210 to access data from the data source 118. For example, the function result 208 may map the query data object 202 to the current match data 211, the current player data 212, the historical team data 213, the historical player data 214, the other data 215, the graphics 270, the videos 271, predictions 272, odds 273, or the editorials 274 associated with the query data object 202. In some examples, one or more of the data from the data source 118 (e.g., graphics 270 or videos 271) may be located on an external server that may be accessed through an API (e.g., utilizing an AI Agent and Tool).

The current match data 211 may include the following example information for a particular sporting event that is in progress or about to occur: the time left in the game, the score of the game, the number of fouls/penalties in a game, the players involved in the sporting match, the referee(s) assigned, sporting surface information, etc. The current player data 212 may include specific player statistics related to a particular sporting event that may be live or upcoming. This may include, for example, data regarding each player's projected and/or current goals, assists, passes, penalties, saves, time on the field, etc. This may further include player physical metrics (e.g., distances ran, sprint speed, high intensity effort (“HIE”) intervals, etc.).

The historical team data 213 may include, for a particular team in a league, the team's wins and losses vs respective opponents, the total goals on the year, the total assists on the year, the record vs respective teams over a period of time, the date of all games, the attendance per game, whether particular games are home/away, etc. The historical player data 214 may include, for a particular player, their goals, passes, assists, fouls (e.g., yellow cards and red cards), expected goals per game over a set period of time (e.g., over a season or over a player's career). Other data 215 may include information related to a particular team preferred line-ups, in-depth historical statistics, team statistics and aggregations over given metrics, weather from current or previous sporting events, player ratings, excitement ratings and/or headlines, injury data, environmental data, managerial data, referee data, generated metrics, or statistical odds of a particular team or player for an upcoming match.

Graphics 270 may include player radar, carry plots, images of highlights and key events from the sporting event. Videos 271 may include press conferences, match preview/recaps, and or highlights. Predictions 272 may include match prediction, season simulation, and/or team and player propositions. Odds 273 may include statistical odds for match outcome or events occurring during and/or before a sporting event. Editorials 274 may include player bios, match previews, and/or recaps. In some examples, the editorials may have been generated by a natural language processing module.

The identification module 122 may receive the function result 208 and identify at least one particular data source 216 from the data source 118, based on the function result 208. The identification module 122 may transfer the information (representing the identified data source/data), along with the original query data object 202 to a prompt and summary module 124. The identification module 122 and the prompt and summary module 124 may be located within the same computing system 104 or within separate computing systems.

The prompt and summary module 124 may be configured to compile an original question (e.g., based on query data object 202) along with at least one data source most applicably associated with a particular question, and feed this information to a machine learning system (e.g., machine learning model 126) with a second prompt to request a result. The prompt and summary module 124 may, for example, be a separate process or processor than the identification module 122. In another example, the prompt and summary module 124 and the identification module 122 may be operated using the same or a similar set of processes or processors.

The prompt and summary module 124 may be configured to prepare input 222 for the machine learning model 126, where the input 222 includes the query data object 202, the at least one determined data source, and a second prompt. The prompt and summary module 124 may identify whether the data source identified from function result 208 is historical data (e.g., historical team data 213 or historical player data 214) or current data (e.g., current match data 211 current player data 212), other data 215, graphics 270, videos 271, predictions 272, odds 273, and/or editorials 274. The prompt and summary module 124 may be configured to access data 226 from the data source 118. For example, the prompt and summary module 124 may implement one or more AI Agent and Tools for accessing relevant data stored in an external server. Each of the AI Agent and Tools may be a machine learning model trained to do a particular task. In this case, each AI Agent and Tool may be trained to extract relevant information from a particular data source. In some examples, the prompt and summary module 124 may include an AI Agent and Tool for each external server, wherein the AI Agent and Tool includes a particular API to extra relevant data from the external server. This may include the ability to extract widget embedded code, graphic URL with particular parameters, and URLs to videos. The prompt and summary module 124 may include an AI routing-agent (e.g., an LLM) configured to associate the particular data source with a particular AI Agent and Tool, and to provide instructions to the particular AI Agent and Tool to extract the relevant information.

The AI agent and tools may be able to determine whether a core task can be dealt with based on the respective assigned data from the data source 118. In some examples, the AI routing-agent may be configured to recognize that a particular AI Agent and Tool may not be able to access the requested information. If the respective task cannot be completed, the one or more AI agent and tools of the prompt and summary module 124 may determine an output that the user query data object 202 cannot be answered. In some examples, the prompt and summary module 124 may prepare a request for the content machine learning model 275 to create the requested data. In some examples, the AI Agent and Tool may be able to access ancillary information or relevant information, which may be forwarded to the machine learning model 126 to assist with generating a response.

The prompt and summary module 124 may be configured output a payload (e.g., input 222) with a feed of an identified data source. If the function result 208 is historical data, the prompt and summary module 124 may output a payload (e.g., input 222) requesting the machine learning system to modify a given SQL query and instruct the system to modify the database so as to extract data that responds to the user query data object 202 based on a historical data source. If the prompt and summary module 124 receives a function result 208 of other data 215, the prompt and summary module 124 may output a payload (e.g., input 222) providing a description of a relational database (e.g., other data 215) with a request to have the machine learning system create a SQL query that may answer the user query data object 202 based on data source storing the other data 215.

For example, based upon the identified data source, a response to a user query may be generated by performing a query on a relational database or by extracting data from a particular database (e.g., through an AI Agent and Tool). The input 222 may further be based on a particular language or tone request for a textual summary output (e.g., as provided via query data object 202). The input 222 may also include a desired output for the requested response. For example, a particular format may be included in the second prompt transferred through input 222.

In some examples, a machine learning model 126 may be configured to identify that a requested response is not currently generated. For example, a requested highlight may not be available in a videos 271 database. In this scenario, the machine learning model 126 may output to the prompt and summary module 124 that the requested content must be created. In some examples, the prompt and summary module 124 may determine that the requested data does not exist through an AI Routing Agent. These scenarios may allow for the prompt and summary module 124 (or another component of the computing system 104) to access a content generation machine learning model 275. The content generation machine learning model may receive a request 276 to generate a particular output. In some cases, relevant data may be provided to content generation machine learning model 275 to assist with generation of new content (e.g., sports content not currently stored in the data source 118). For example, if a highlight is requested, videos from the sporting event and related event data may be transferred to the content generation machine learning model 275 to assist in generating the response. The content generation machine learning model 275 may then generate a response to transfer back to the computing system 104 which may be sent to the client device 108.

The machine learning model 126 may be configured to determine a multi-modal result 224 to the user query data object 202. Multi-modal may be defined as having one or more formats. The result 224 may be in a specified format such as text, graphics, videos, or widgets. The result 224 may be based on an input that includes a particular data set identified by function result 208. The result 224 may be sent to the prompt and summary module 124. The results 224 may then be transferred as a multi-modal response 227 to the client device 108. Alternatively, according to an embodiment, machine learning model 126 or other applicable component may output the result 224 directly to the client device 108 (not shown).

FIG. 2B is a block diagram of a response generation environment 200B, according to one or more embodiments. Environment 200B may be an alternative embodiment of environment 200A, though it includes certain similar components and processes as those disclosed in reference to environment 200A. For simplicity, such similar components and processes are not discussed again in reference to environment 200B.

The environment 200B may include the client device 108, the identification module 122, a machine learning model 126, and a prompt and summary module 124.

The identification module 122 (e.g., a function identification module) may receive a user query data object 202 from a client device 108. The identification module 122 may generate and provide a prompt 206 to the machine learning model 126 requesting a particular data source/function that corresponds to the query data object 202.

The data source/function information may be stored at data source 118 (as shown) or may be stored at a separate location. The data source/function information may include code or pointers that point to a corresponding data source or function. The data source/function information may include one or more of the current match data 211, the current player data 212, the historical team data 213, the historical player data 214, other data 215, non-sports questions block 250, graphics 270, videos 271, predictions 272, odds 273, and/or editorial 274. The non-sports questions block 250 may not be related to a particular team or player of a sporting event. The data source 118 may further include a null answer block 252. The null answer block 252 may be identified if it is determined that the user query does not correspond to a data source and/or function that is available to environment 200B.

The machine learning model 126 may output a function result 208 assigning a particular data source/function to the query data object 202. The machine learning model 126 may be trained based on historical or simulated queries and tagged or untagged data set functions. These machine learning models may be trained to output a data set function based (function result 208) on a received query data object 202. As discussed herein, machine learning model 126 may output a function result 208 identifying a subset of the data sets or functions available to environment 200B. The function result 208 may be transferred to a prompt and summary module 124 (e.g., a “CALL GPT” module configured to trigger a generative machine learning module). Accordingly, the prompt and summary module 124 may receive a user query as well as an applicable data source associated with the query.

The prompt and summary module 124 may compile an original question (e.g., query data object 202) along with data from the selected data source most associated with a particular user query. Depending on the determined data source, the prompt and summary module 124 may respond in one of a plurality of manners. For example, a first option may be triggered when current data (e.g., current match data 211, current player data 212, graphics 270, videos 271, predictions 272, odds 273, or editorials 274) is determined the data source based on function result 208. A second option may be triggered when historical data (e.g., historical team data 213, historical player data 214, or other data 215) is determined based on function result 208. A third option may be triggered when a non-sports question (e.g., determined at a non-sports questions block 250) is determined based on function result 208. A fourth option may be triggered when the null answer block 252 block is determined based on function result 208.

If the determined data source is the current match data 211, current player data 212, graphics 270, videos 271, predictions 272, odds 273, or editorials 274, then the prompt and summary module 124 may feed the machine learning model 126 input 222a. Input 222a may include the query data object 202, data from the selected data source, and a second prompt to answer the query data object 202 based upon the data from the selected data source. The second prompt may further include a preferred output format for the response (e.g., as text, image, video, widget, etc.) The selected data source may, for example, be stored locally. The machine learning model 126 may generate a response (e.g., a multi-modal response) based on the input 222a and the corresponding data from the selected data source. The machine learning model 126 may output the response as response 224a. This response 224a may be saved (e.g., as a current game statistic 258) and may be output as a reply 262 to a user (e.g., using the client device 108).

In some examples, when the selected data source is historical data (e.g., historical team data 213, historical player data 214, or other data 215), the prompt and summary module 124 may call 260 a relational database 218 (e.g., associated with data source 118 (as shown) or external to data source 118). The relational database 218 may be called based on historical statistics 259 identified based on the user query such that the relational database provides data in response to the user query based on the historical statistics 259. The relational database 218 may output historical data (e.g., in an SQL format) to provide data in response to the user query. The received data may be provided to a prompt and summary module 124 which may output a reply 262 to the user, based on the received data.

Alternatively, the prompt and summary module 124, upon receiving the applicable historical data may provide, as inputs 222b to the machine learning model 126, the historical data, the query data object 202, and a prompt requesting the machine learning system to parse, analyze, modify, and/or extract the data in order to answer to the user question. The machine learning model 126 may determine a summary response 224b and output summary response 224b to the prompt and summary module 124. This response 224b may be summarized, saved, and/or output as a reply 262 to a user (e.g., through the client device 108).

In some examples, the machine learning model 126 may utilize the received data source and attempt to determine an answer unsuccessfully. For example, the machine learning model 126 may be attempting to locate a particular highlight that has not been created. In this scenario, the machine learning model 126 may determine that the particular response needs to be generated externally. The response from the machine learning model 126 may output that a response could not be generated and that a separate system (e.g., the content generation machine learning model 275) must be accessed to generate a response. In these examples, the machine learning model 126 may determine any data from the data source that may be necessary for the content generation machine learning model 275 to generate a response. Then the computing system 104 (e.g., through prompt and summary module 124) may request the generation of the requested content and provide any needed data for the generation. The content generation machine learning model 275 may be configured to generate items such as, but not limited to, highlights, clips, editorials, drawings, predictions, and odds upon request.

The scenario where the content generation machine learning model 275 is accessed may be when the initial user query is fact based or based on a tangible action that occurred in a sporting event. In cases where the initial user query data object 202 is non-factual content, the machine learning model 126 may be configured to output that an answer cannot be generated when the prompt and summary module 124 is unable to access relevant information.

When the data source, determined based on function result 208, corresponds to a non-sports questions block 250, the prompt and summary module 124 may initiate a call non-sports question 254 (other sport question) block to trigger a search engine 256 based query requesting a search engine based response to a user query. For example, the query data object 202 may be input into the search engine 256 as a transformed version of query data object 202 may be input into the search engine 256 in a format acceptable by search engine 256. The search engine 256 may determine a set of answers based on the received search engine query. The set of answers may be a select number of results from the search engine 256. For example, the set of answers may include the top ten results provided by the search engine 256. The set of answers may be uploaded as input 257 to the prompt and summary module 124. The prompt and summary module 124 may then provide, as input 222b (e.g., the content of the input 257) the query data object 202, and a prompt requesting a machine learning system to determine an answer to the query data object 202 based upon the input 222b. The machine learning model 126 may generate a response 224b and output the response to the prompt and summary module 124. This response 224b may be summarized, saved, and/or output as a reply 262 to a user (e.g., through the client device 108).

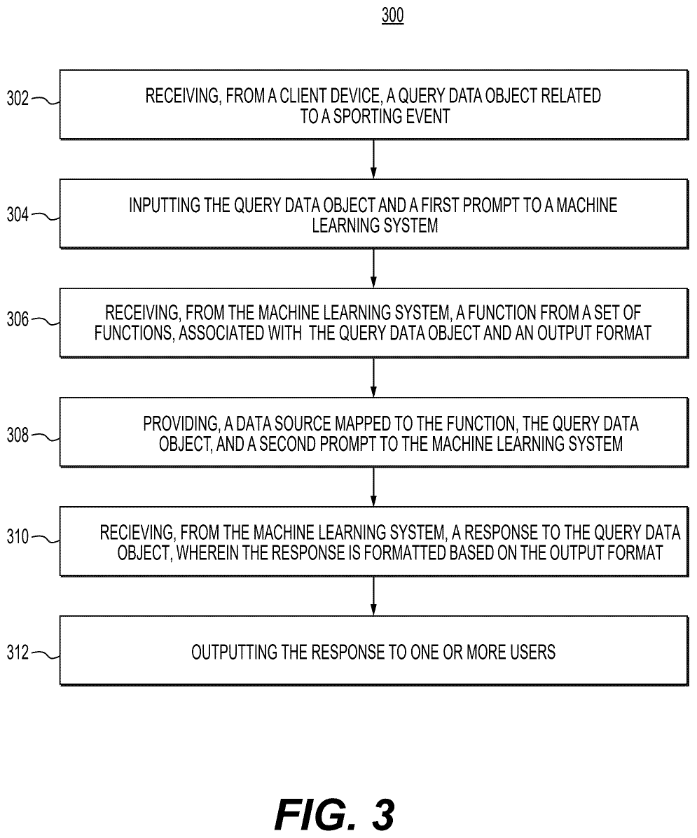

FIG. 3 is a flow diagram of an exemplary method 300 for using machine learning models to generate a multi-modal response to a received query, according to one or more embodiments. The method 300 may be implemented by environment 200A or environment 200B.

At step 302, the system (e.g., environment 200A or environment 200B) may receive, from a client device (e.g., client device 108), a query data object related to a sporting event. The query data object may be a question about a player or team of a sporting event, a request for a prediction related to a sporting event, a request for a highlight, or the like. As non-limiting examples the query data object may be: 1) how many goals did player X score in the past 5 games, 2) how many miles has player X run in the current game, or 3) what was the results from the last three times teams Y and Z played each other. The query data object may further include preferences (e.g., functions) for a language, topic, style, tone, or format for the requested response. For example, the query data object may be a request for a video of a sports highlight or a graph of the predictions for a selection of sporting event games. The query data object may be related to a player, team, graphic, video, prediction, and/or odds of the sporting event.

In some examples, the query data object may be selected from a set of template options available to a user through a user interface. An exemplary user interface may be displayed as shown in FIG. 6 discussed below and exemplary templates of questions may be displayed as shown in FIG. 7 discussed below.

At step 304, the system (e.g., the identification module 122) may input the query data object and a first prompt into a machine learning system. The first prompt may include instructions readable by the machine learning system. The first prompt may include: the set of functions; a description of each function from the set of functions; and a machine readable request instructing the machine learning system to associate the query data object with one of the set of functions based on the descriptions of each function. According to embodiments, the set of functions and/or the description of each function may be previously available to or accessible by the machine learning system. According to these embodiments, the first prompt may include the query data object, and the machine learning system may identify an associated function based on previously available or accessible set of functions. The set of functions may each map to respective data sources and types of information. For example, the set of functions may map to the data sources within data source 118 of FIG. 2A and FIG. 2B. The types of functions/data sources may include, for example, a current match state function, a current player state function, a historical team function, a historical player function, other sports function, a non-sports function, a graphic function, videos function, predictions function, odds function, editorial functions, and or generation functions.

The first prompt may further include a set output formats, a description of each output format, and a machine readable request with instructions that the machine learning system associate the query data object with the output format from the set of output formats. Exemplary outputs may include graphics, audio, images, videos, image overlays, or a textual response. The response may further request the output be in the format of a widget as opposed to only text, graphics, or videos. The formats may correspond to the requested output style for the query data object.

At step 306, the system may determine, using the machine learning system (e.g., the machine learning model 126), a function, from the set of functions that the query data object is associated with. The determined function/data source may be output/saved. The function/data source may correspond to a data source most related to the query data object. The machine learning system may further determine an output format. In some examples, the user data query object may directly request a data format, and in other examples, the machine learning model may infer a desired output format for the query data object. For example, if a highlight is requested, the machine learning model 126 may determine the desired output format of the response is a video.

At step 308, the system (e.g., the prompt and summary module 124) may input a data source mapped to the function, the query data object, and a second prompt to the machine learning system(s) (e.g., machine learning model 126). The second prompt may further include any preferences such as language, topic, style, tone, or format for the requested response into the machine learning system.

If the data source mapped to the function is a given type (e.g., historical team stat function, historical player stats function, other sport function, etc.), the system may further include accessing a database; requesting historical information; and receiving the historical data (e.g., in an SQL query format). This determined historical data (e.g., in SQL query format) may be included as input to the machine learning system with the query data object from step 302 and the second prompt. For example, the second prompt may include instructions for the machine learning system to adapt the SQL query to extract data that responds to the query data object from step 302.

In some examples, the system may provide current data from local storage to the machine learning system(s) along with the query data object from step 302 and the second prompt. The data provided may have been the identified data source/function from step 306. The second prompt may include instructions for the machine learning system to answer the query data object from step 302 based on identified data source/function from local storage (e.g., data source 118).

In some examples, an AI Agent or tool (e.g., from the prompt and summary module 124) may be utilized to retrieve relevant data for the machine learning system (e.g., machine learning model 126). For example, an AI routing agent may review the selected function from step 306 and assign a particular AI Agent or tool to extract the relevant information from a particular server. The AI Agent or tool may be configured to extract the relevant data in an optimal format. For example, URLs, embeddings, summaries of data, or direct data files may be extracted by the AI Agent or tool to be sent to the machine learning system. This may assist with the machine learning model having the most relevant data when generating a response.

If the identified function is a non-sports question, the system may further include performing a search for the query data object through a search engine. These results may be saved and uploaded, with the query data object from step 302 and the second prompt, to the machine learning system. The second prompt may include machine readable instructions for the machine learning system to answer the query data object from step 302 based on the results from the internet browser.

At step 310, the system may determine, using (1) the query data object, (2) the data source mapped to the function, and (3) the second prompt, a response to the query data object. This may be performed by the machine learning system (e.g., machine learning model 126). The output responses may be formatted specifically based on the user query. The system may be multi-modal in that the system may generate responses for a variety of formats such as text, graphics, videos, widgets, etc.

In some examples, the machine learning system may determine that it does not have access to a desired response from the received data source. For example, an editorial or highlight requested may not exist in the data source. In this example, the system (e.g., the machine learning model 126 or the prompt and summary module 124) may access a separate content generation machine learning model (e.g., content generation machine learning model 275). The separate content generation machine learning model may provide any relevant data sources and a request to generate content based on the query data object. For example, the separate content generation machine learning model may be utilized to create highlights not currently saved in the local data source or not previously created. A response may then be generated by the separate content generation machine learning model.

At step 312, the system may output the response to one or more users. The response may include the machine learning generated answer to the query data objected. The response may be in formatted based on the query data object.

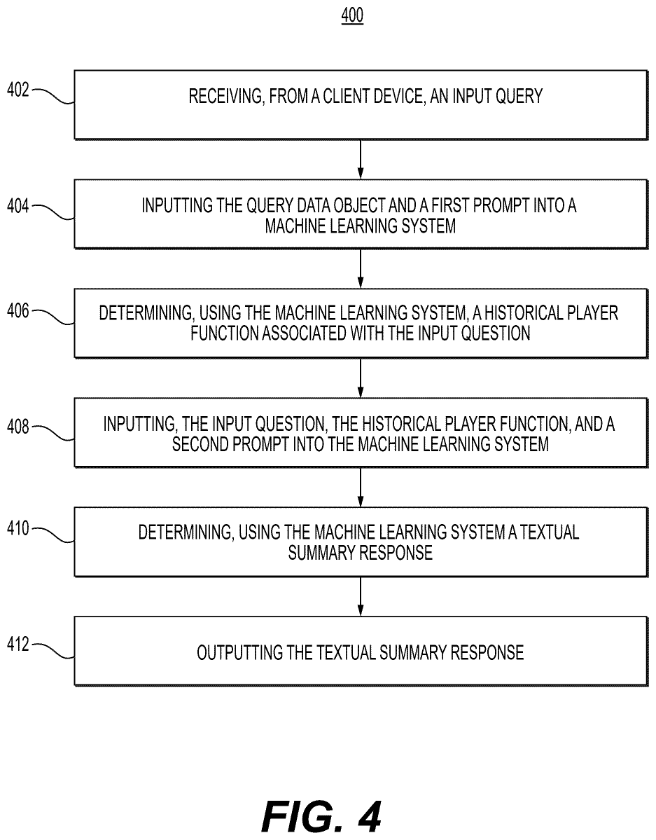

FIG. 4 is a flow diagram of an exemplary method for using machine learning models to generate textual answer prediction in response to a historical sports question, according to one or more embodiments. The method 400 may, for example, be implemented by environment 200A or environment 200B.

At step 402, a user may input (e.g., through client device 108): a question related to the historical performance of one or more players in a game. For example, the input questions may be “how many goals did player X score against team Y in the previous five matchups.” The input question may be recorded and saved as the query data object.

At step 404, the query data object may be inserted along with a first prompt, and a set of data sources into a machine learning system. The first prompt may include the set of functions; a description of each function from the set of functions; and a machine readable request instructing the machine learning system to associate the query data object with one of the set of functions based on the descriptions of each function. The set of functions may be mapped to respective data sources and types of information. The types of functions/data sources may include a current match state function, a current player state function, a historical team function, a historical player function, another sports function, or a non-sports function.

At step 406, the machine learning system may determine that the historical player function is associated with the query data object and output an indication identifying the query data object. Upon determining the historical player function is accolated with the query data object, the system may extract from a separate database, a relational database with the historical player data. This data may be stored as an SQL query.

At step 408, the system may input the query data object, the historical player function, and a second prompt to the machine learning system. The second prompt may include instructions for the machine learning system to adapt the SQL query to extract data that can be used to respond to the query data object and to prepare a textual summary response.

At step 410, the machine learning system may, based on the second prompt and using the historical player data, determine a textual summary response. At step 412, the textual summary response may be output to a user.

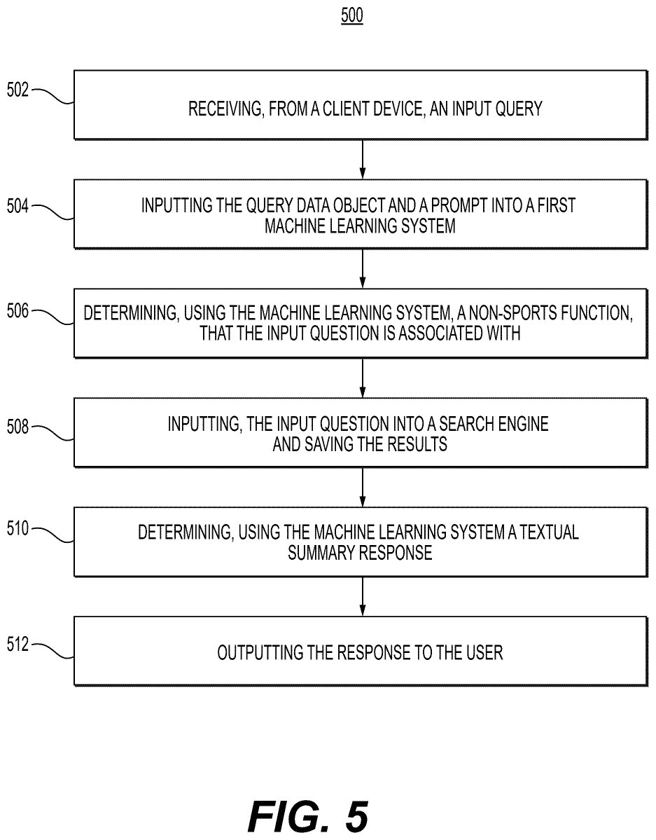

FIG. 5 is a flow diagram of an exemplary method 500 for using machine learning models to generate textual answer prediction in response to a non-sports question, according to one or more embodiments. The method 500 may, for example, be implemented by environment 200A or environment 200B.

At step 502, a user may input (e.g., through client device 108): a question not related to sporting event data. For example, the input questions may be “how old is Ronaldo.” This question may be recorded and saved as the query data object.

At step 504, the query data object may be inserted along with a first prompt, and a set of data sources into a machine learning system. The first prompt may include the set of functions; a description of each function from the set of functions; and a machine readable request instructing the machine learning system to associate the query data object with one of the set of functions based on the descriptions of each function. The set of functions may each have functions that are mapped to respective data sources and types of information. The types of functions/data sources may include a current match state function, a current player state function, a historical team function, a historical player function, another sports function, or a non-sports function.

At step 506, the machine learning system may determine that the non-sports function is associated with the query data object and output an indication based on the same.

At step 508, the system may, upon determining the function type is the non-sports function, input the query data object into a search engine accessed via the network. A set of results may be saved.

At step 510, the results from step 508 and the query data object may be input into the machine learning system with a second prompt. The second prompt may include instructions for the machine learning system to form a textual summary response based on the set of results from the search engine. A textual summary response may be determined and saved based on this information. At step 512, the textual summary response to the user question may be output to the user.

FIG. 6 is an exemplary user interface 600 for a response generation environment (e.g., environment 200A or environment 200A), according to one or more embodiments. For example, the user interface may be of a client device 108 from FIG. 1, 2A, or 2B. The user interface 600 may include a text box that may receive text that is converted to the user query data object. The user interface 600 may further include template/example prompts that may be selected by a user. Through the user interface, the use may further narrow a prompt to a particular type of sporting event, league, game, or player through a filter.

FIG. 7 is an exemplary block diagram of exemplary user query templates displayed on a user interface 700, according to one or more embodiments. These may include examples that a user may select to request a response from the system described herein. The query templates may include a variety of requested formats of response (e.g., text, widgets, graphics, widget, videos, etc.).

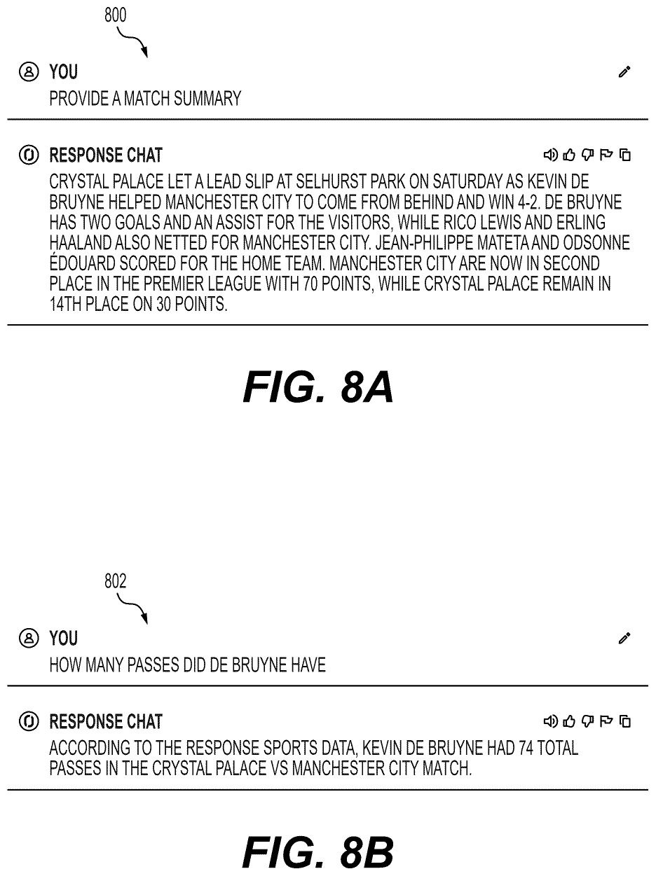

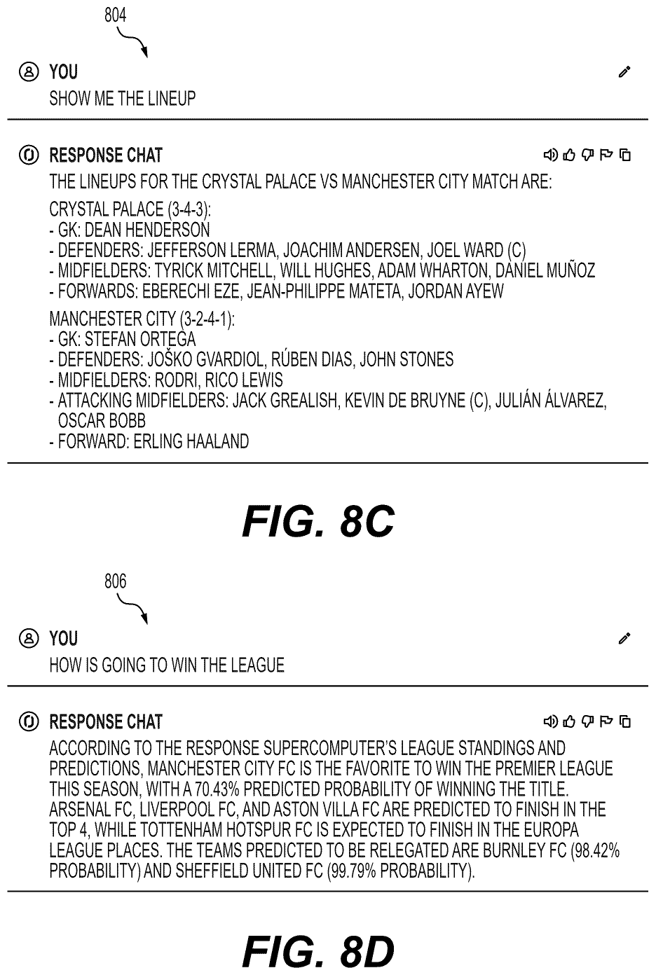

FIG. 8A-8D are exemplary generated data formatted responses, according to one or more embodiments. These may be example user queries and generated responses generated by the system described herein. The example response may be generated based on retrieved data. The system may have relied on current match data 211, current player data 212, historical team data, and/or historical player data 214 to generate the responses in FIG. 8A-8D. FIG. 8A may display a user interface 800 of a query and generated response from the system described herein.

FIG. 8B may display a user interface 802 of a query and generated response from the system described herein. FIG. 8C may display a user interface 804 of a query and generated response from the system described herein. FIG. 8D may display a user interface 806 of a query and generated response from the system described herein.

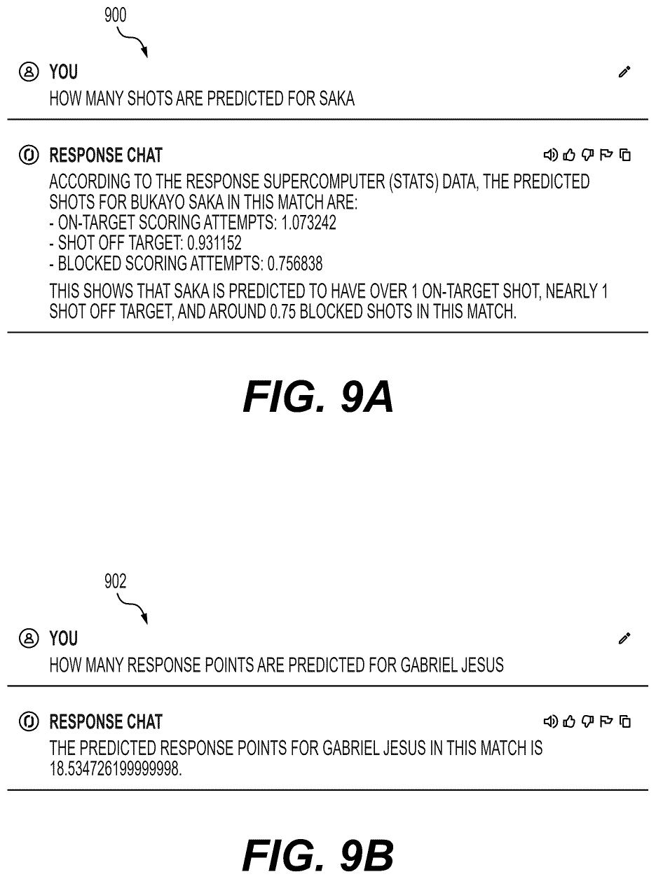

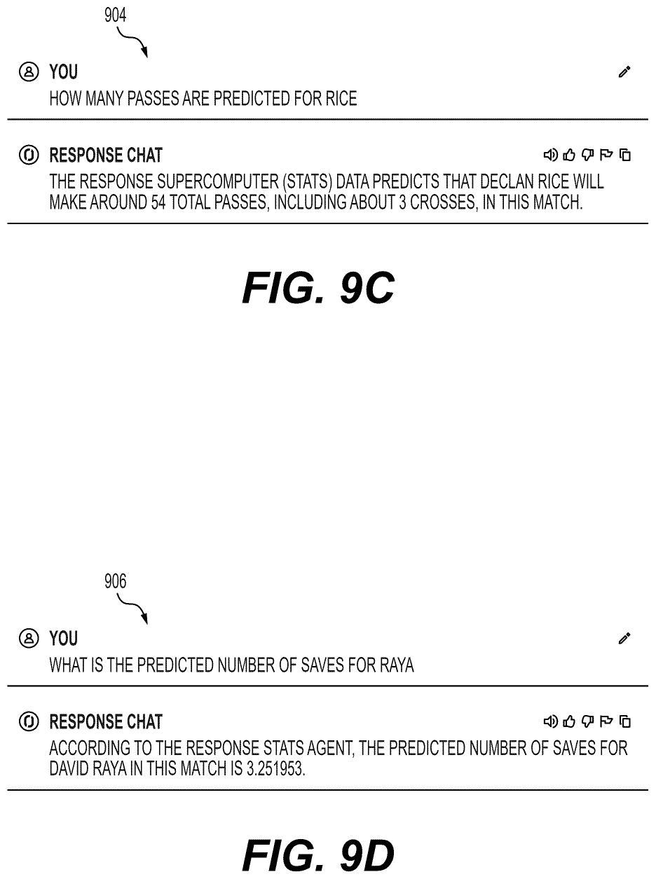

FIG. 9A-9D are exemplary generated prediction formatted response, according to one or more embodiments. These may be example user queries and generated responses generated by the system described herein. The example responses may be generated based on prediction 272. FIG. 9A may display a user interface 900 of a query and generated response from the system described herein.

FIG. 9B may display a user interface 902 of a query and generated response from the system described herein. FIG. 9C may display a user interface 904 of a query and generated response from the system described herein. FIG. 9D may display a user interface 906 of a query and generated response from the system described herein.

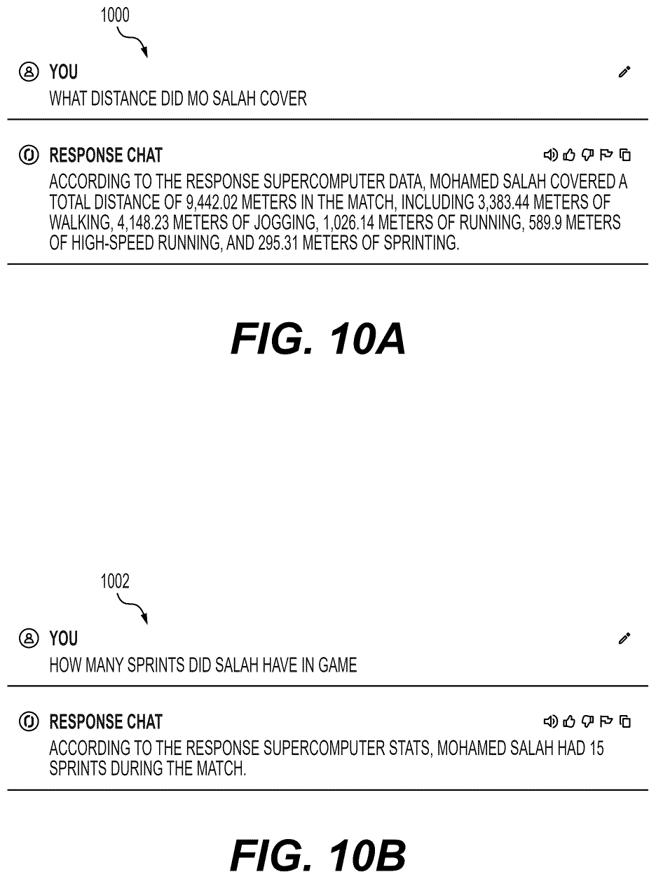

FIG. 10A-10B are exemplary generated player metric formatted response, according to one or more embodiments. These may be example user queries and generated responses generated by the system described herein. The example responses may be generated based on current player data 212, that may include physical metric data of players. FIG. 10A may display a user interface 1000 of a query and generated response from the system described herein. FIG. 10B may display a user interface 1002 of a query and generated response from the system described herein.

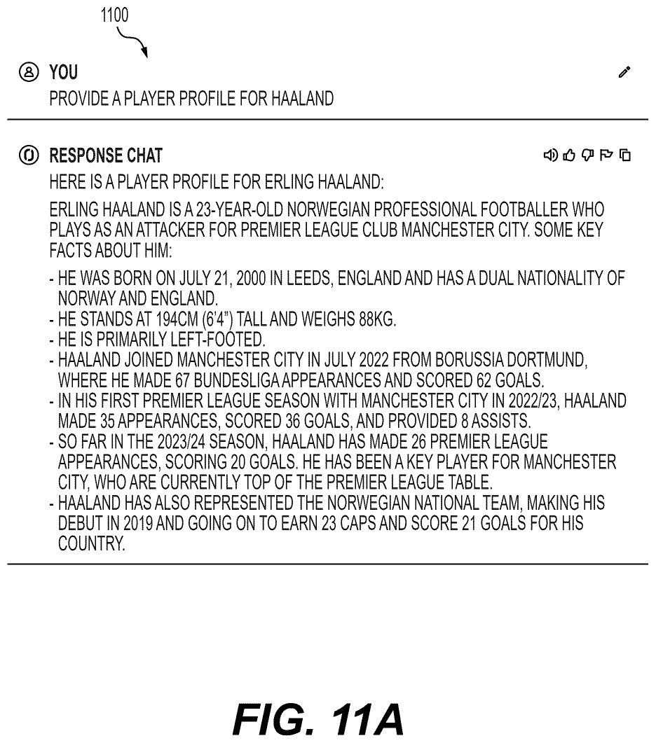

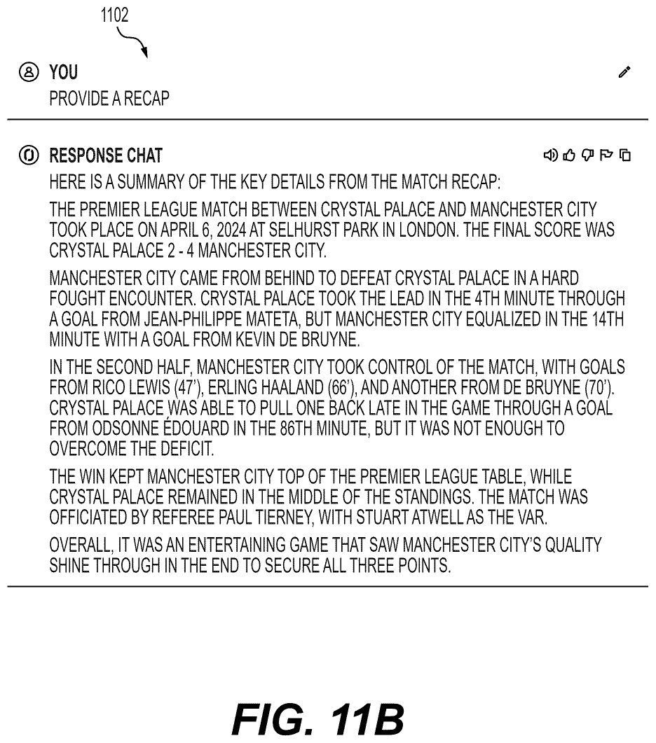

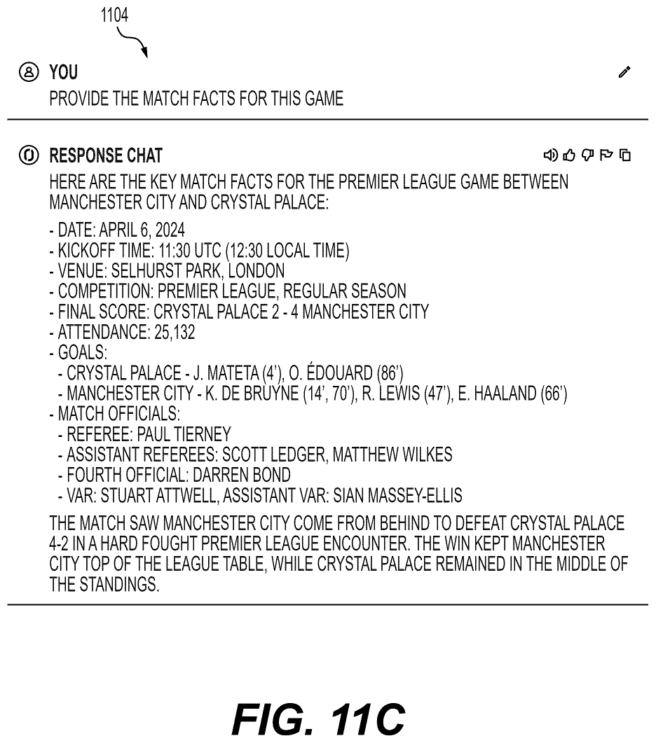

FIG. 11A-11C are exemplary generated editorial formatted response, according to one or more embodiments. These may be example user queries and generated responses generated by the system described herein. The example responses may be generated based on editorials 274. FIG. 11A may display a user interface 1100 of a query and generated response from the system described herein. FIG. 11B may display a user interface 1102 of a query and generated response from the system described herein. FIG. 11C may display a user interface 1104 of a query and generated response from the system described herein.

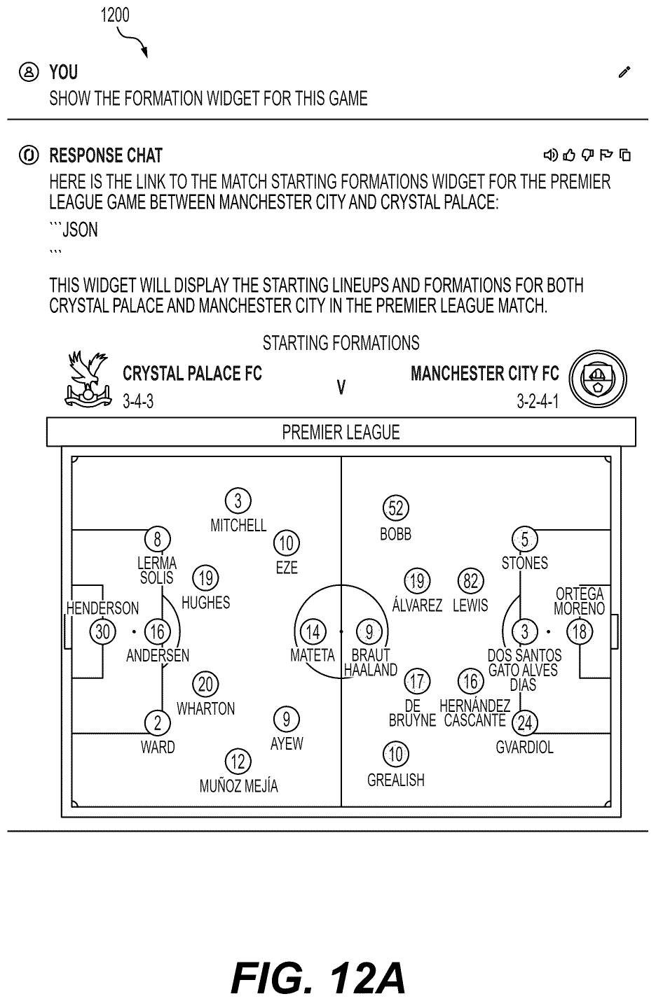

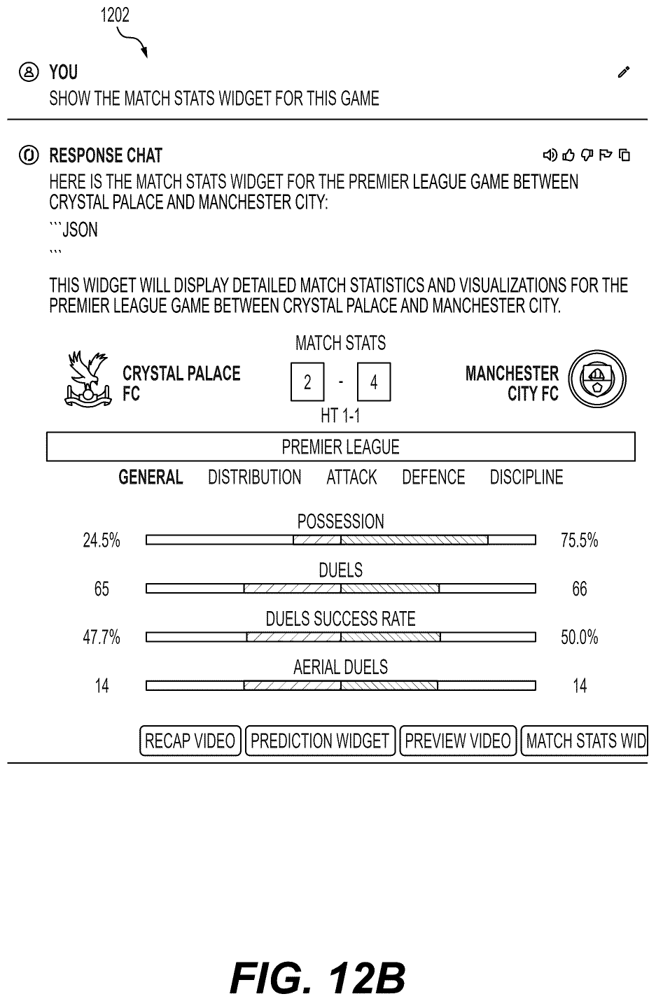

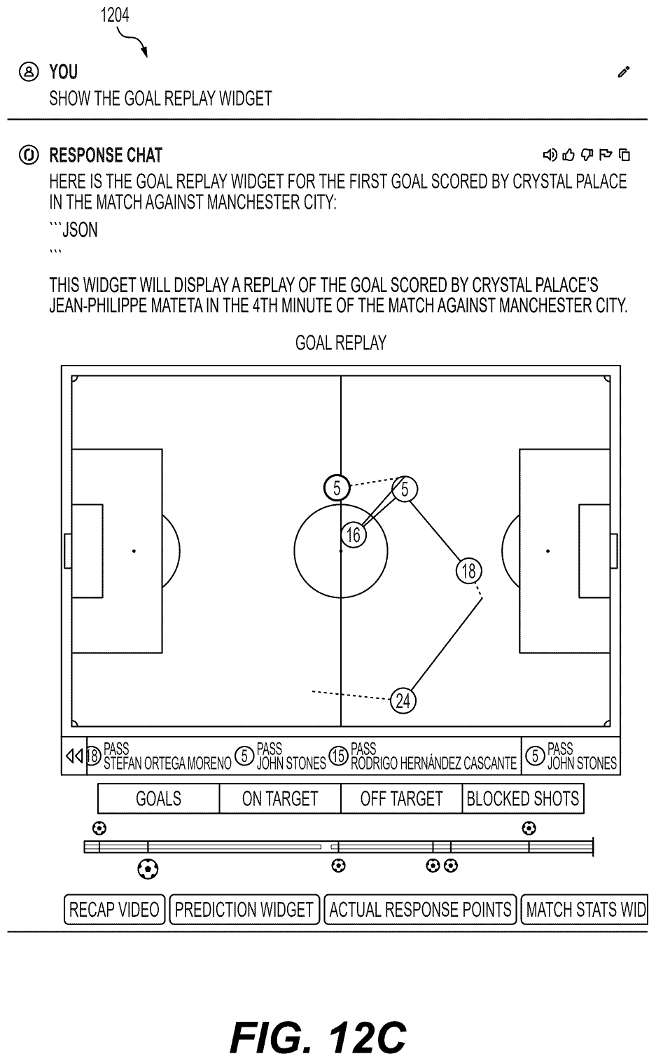

FIG. 12A-12C are exemplary generated widget formatted response, according to one or more embodiments. These may be example user queries and generated responses generated by the system described herein. The example responses may be generated based on current match data 211, current player data 212, graphics 270 and videos 271. FIG. 12A-12C may display outputs formatted in a widget format for the users. FIG. 12A may display a user interface 1200 of a query and generated response from the system described herein. FIG. 12B may display a user interface 1202 of a query and generated response from the system described herein. FIG. 12C may display a user interface 1204 of a query and generated response from the system described herein.

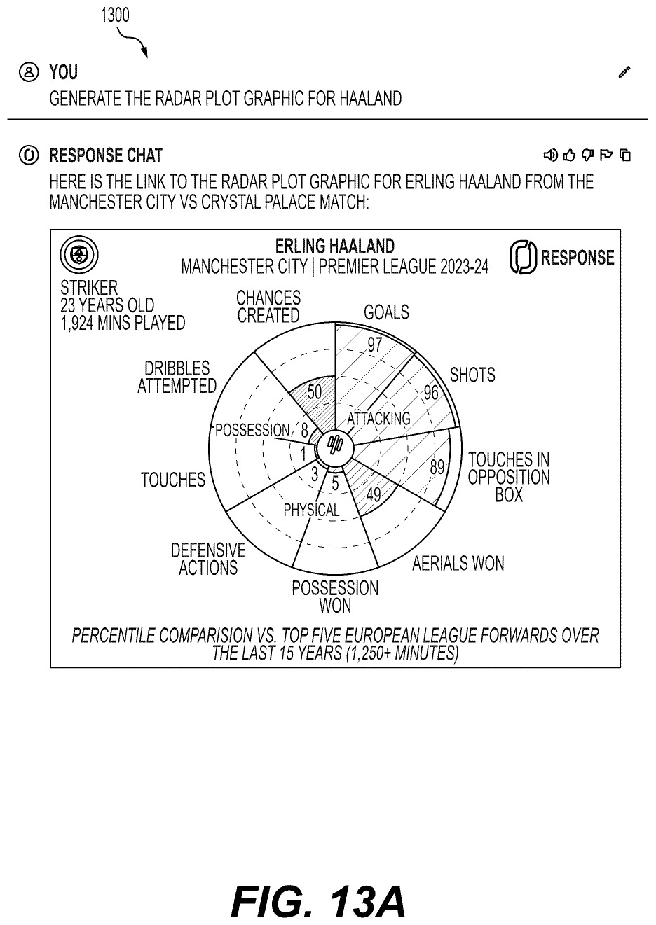

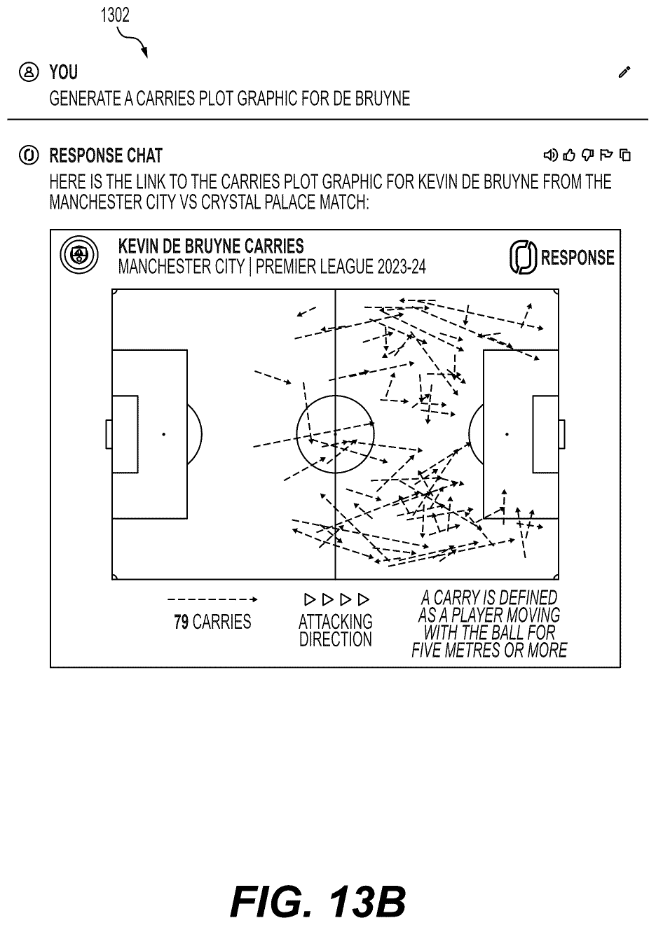

FIG. 13A-13B are exemplary generated graphic formatted response, according to one or more embodiments. These may be example user queries and generated responses generated by the system described herein. The example responses may be generated based on graphics 270. FIG. 13A may display a user interface 1300 of a query and generated response from the system described herein. FIG. 13B may display a user interface 1302 of a query and generated response from the system described herein.

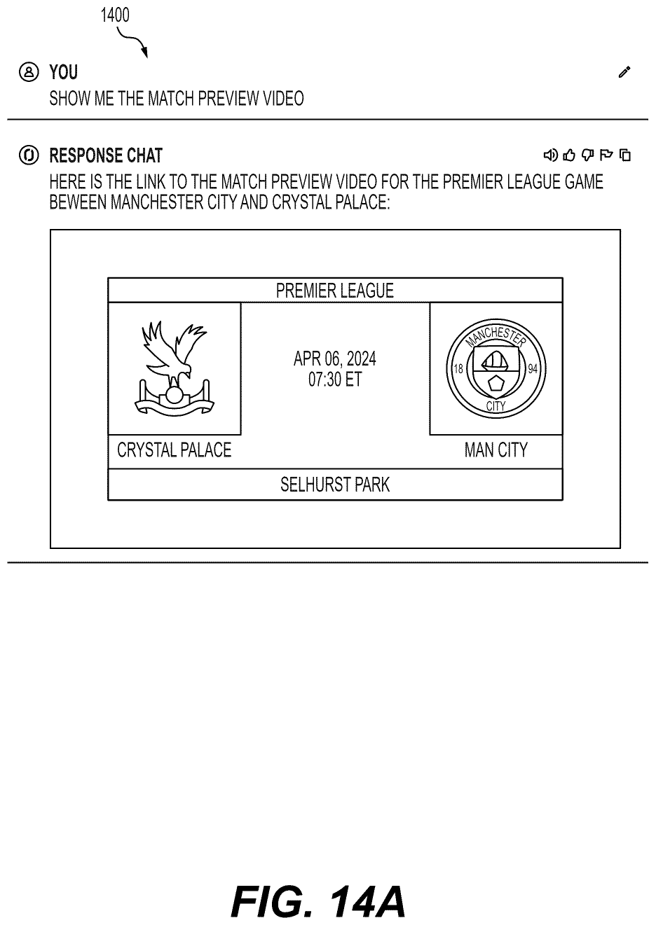

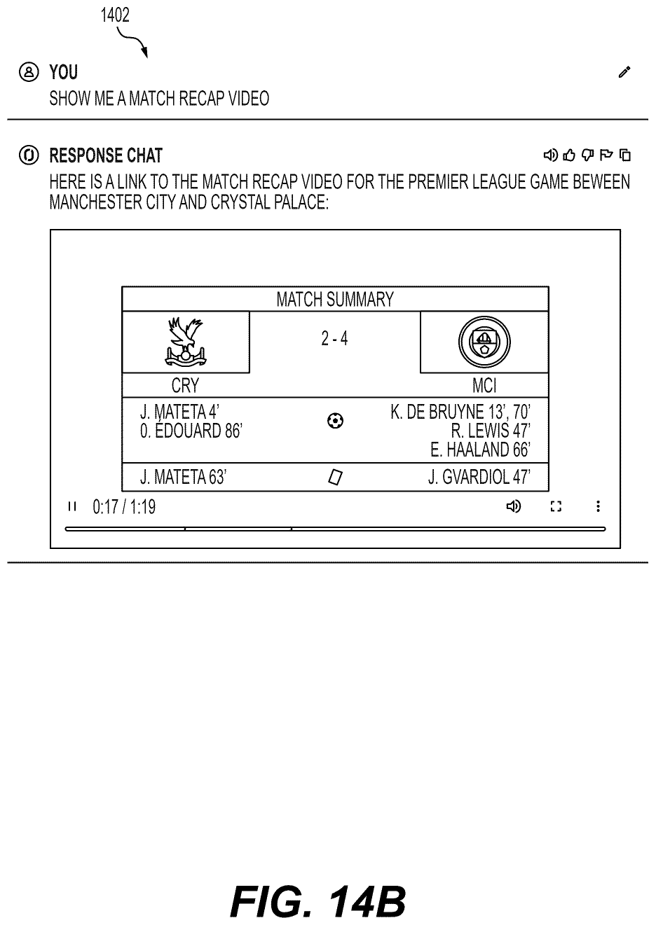

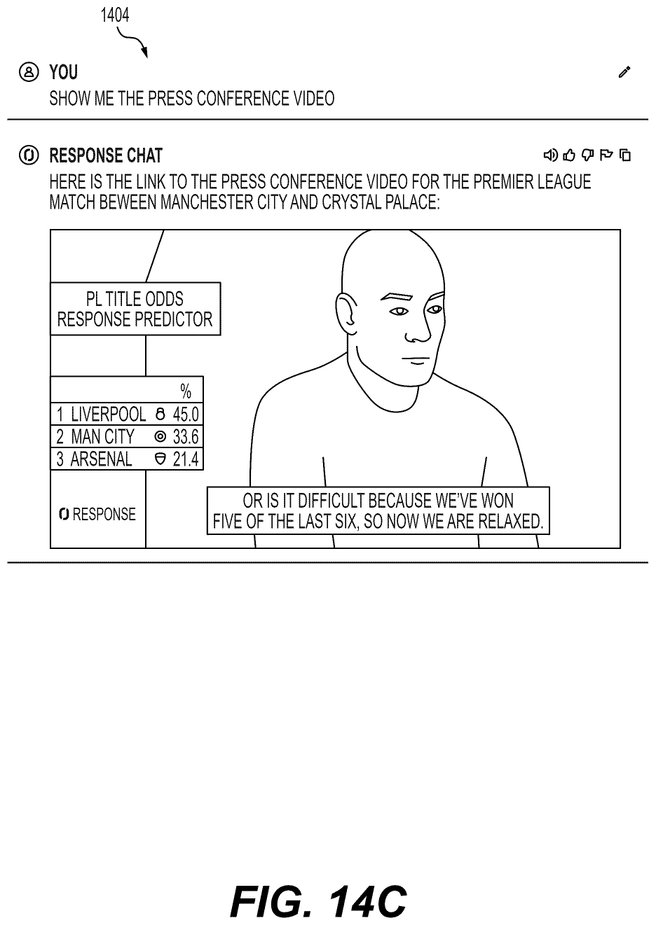

FIG. 14A-14C are exemplary generated video formatted response, according to one or more embodiments. These may be example user queries and generated responses generated by the system described herein. The example responses may be generated based on videos 271. FIG. 14A may display a user interface 1400 of a query and generated response from the system described herein. FIG. 14B may display a user interface 1402 of a query and generated response from the system described herein. FIG. 14C may display a user interface 1404 of a query and generated response from the system described herein.

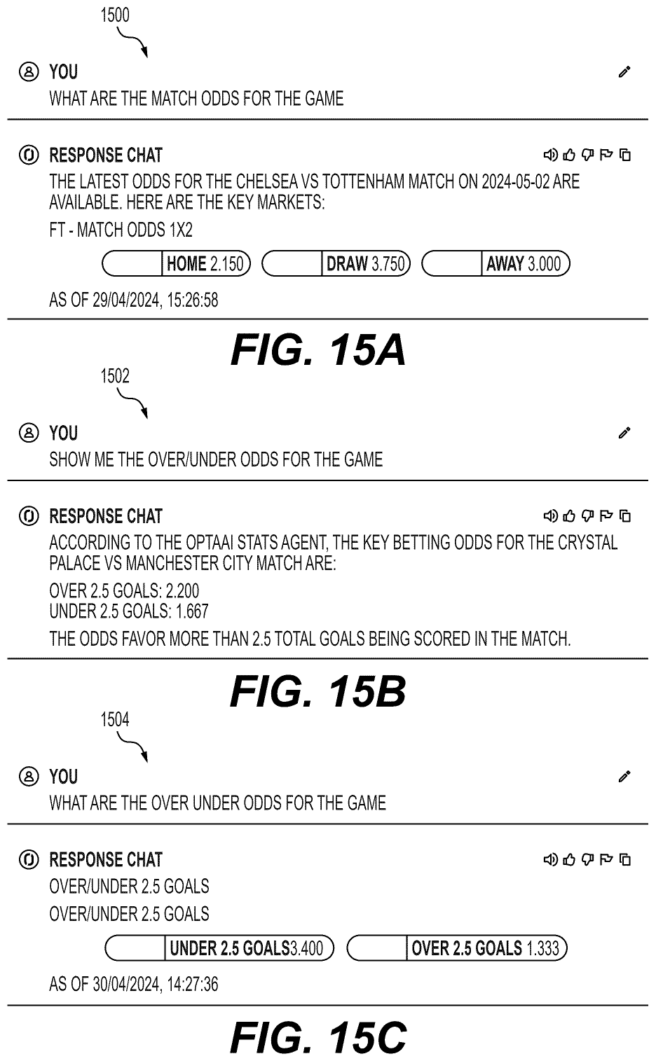

FIG. 15A-15C are exemplary generated odds formatted response, according to one or more embodiments. These may be example user queries and generated responses generated by the system described herein. The example responses may be generated based on odds 273. FIG. 15A may display a user interface 1500 of a query and generated response from the system described herein. FIG. 15B may display a user interface 1502 of a query and generated response from the system described herein. FIG. 15C may display a user interface 1504 of a query and generated response from the system described herein.

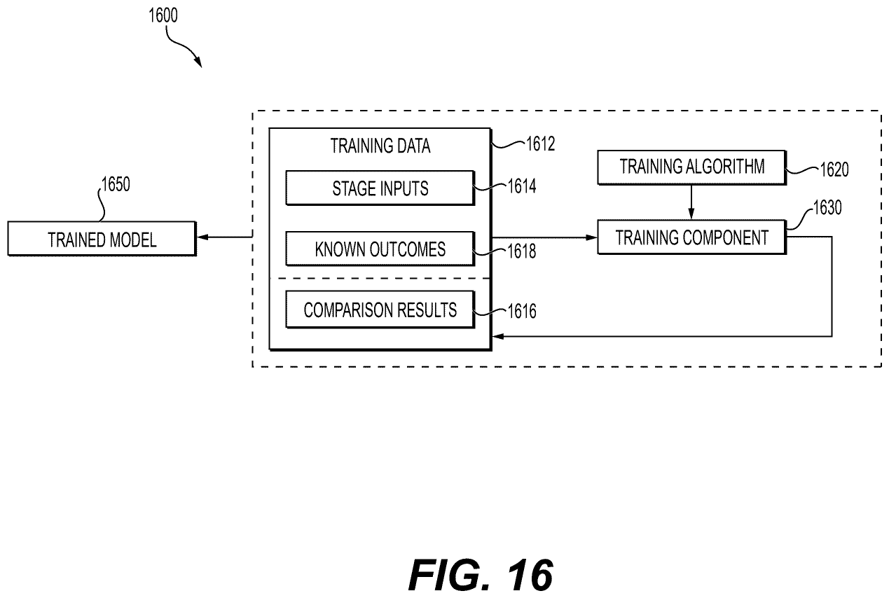

FIG. 16 depicts a flow diagram for training a machine learning model, in accordance with an aspect of the disclosed subject matter. As shown in flow diagram 1600 of FIG. 16, training data 1612 may include one or more stage inputs 1614 and known outcomes 1618 related to a machine learning model to be trained. The stage inputs 1614 may be from any applicable source including a component or set shown in the figures provided herein. The known outcomes 1618 may be included for machine learning models generated based on supervised or semi-supervised training. An unsupervised machine learning model might not be trained using known outcomes 1618. Known outcomes 1618 may include known or desired outputs for future inputs similar to or in the same category as stage inputs 1614 that do not have corresponding known outputs.

The training data 1612 and a training algorithm 1620 may be provided to a training component 1630 that may apply the training data 1612 to the training algorithm 1620 to generate a trained machine learning model 1650. According to an implementation, the training component 1630 may be provided comparison results 1616 that compare a previous output of the corresponding machine learning model to apply the previous result to re-train the machine learning model. The comparison results 1616 may be used by the training component 1630 to update the corresponding machine learning model. The training algorithm 1620 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1600 may be a trained machine learning model 1650.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

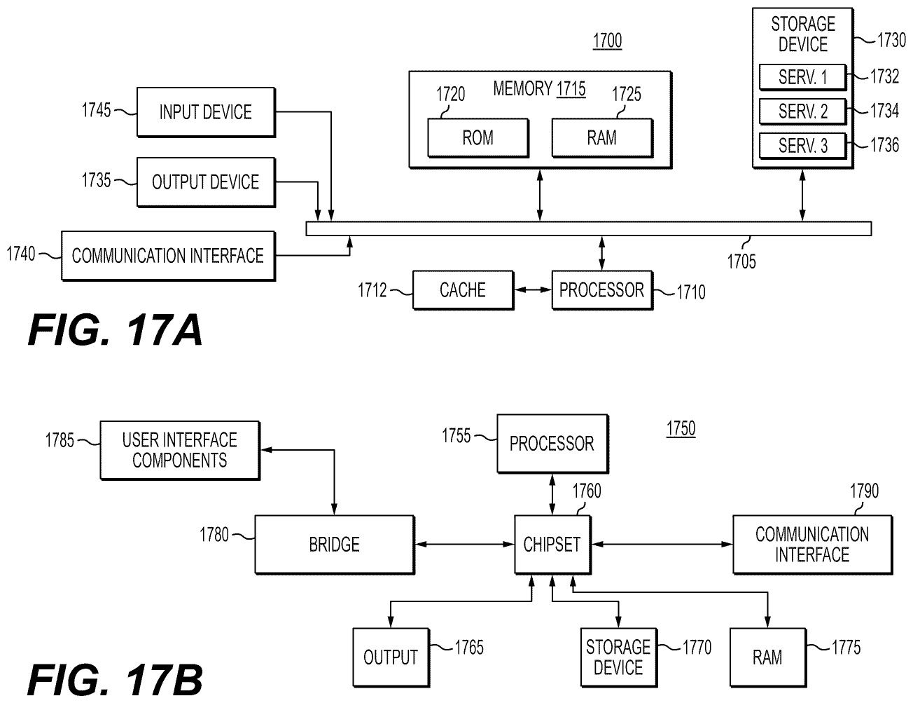

FIG. 17A illustrates an architecture of computing system 1700, according to example embodiments. System 1700 may be representative of at least a portion of organization computing system 104. One or more components of system 1700 may be in electrical communication with each other using a bus 1705. System 1700 may include a processing unit (CPU or processor) 1710 and a system bus 1705 that couples various system components including the system memory 1715, such as read only memory (ROM) 1720 and random access memory (RAM) 1725, to processor 1710. System 1700 may include a cache of high-speed memory connected directly with, in close proximity to, or integrated as part of processor 1710. System 1700 may copy data from memory 1715 and/or storage device 1730 to cache 1712 for quick access by processor 1710. In this way, cache 1712 may provide a performance boost that avoids processor 1710 delays while waiting for data. These and other modules may control or be configured to control processor 1710 to perform various actions. Other system memory 1715 may be available for use as well. Memory 1715 may include multiple different types of memory with different performance characteristics. Processor 1710 may include any general purpose processor and a hardware module or software module, such as service 1 1732, service 2 1734, and service 3 1736 stored in storage device 1730, configured to control processor 1710 as well as a special-purpose processor where software instructions are incorporated into the actual processor design. Processor 1710 may essentially be a completely self-contained computing system, containing multiple cores or processors, a bus, memory controller, cache, etc. A multi-core processor may be symmetric or asymmetric.

To enable user interaction with the computing system 1700, an input device 1745 may represent any number of input mechanisms, such as a microphone for speech, a touch-sensitive screen for gesture or graphical input, keyboard, mouse, motion input, speech and so forth. An output device 1735 (e.g., display) may also be one or more of a number of output mechanisms known to those of skill in the art. In some instances, multimodal systems may enable a user to provide multiple types of input to communicate with computing system 1700. Communications interface 1740 may generally govern and manage the user input and system output. There is no restriction on operating on any particular hardware arrangement and therefore the basic features here may easily be substituted for improved hardware or firmware arrangements as they are developed.

Storage device 1730 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1725, read only memory (ROM) 1720, and hybrids thereof.

Storage device 1730 may include services 1732, 1734, and 1736 for controlling the processor 1710. Other hardware or software modules are contemplated. Storage device 1730 may be connected to system bus 1705. In one aspect, a hardware module that performs a particular function may include the software component stored in a computer-readable medium in connection with the necessary hardware components, such as processor 1710, bus 1705, output device 1735, and so forth, to carry out the function.

FIG. 17B illustrates a computer system 1750 having a chipset architecture that may represent at least a portion of organization computing system 104. Computer system 1750 may be an example of computer hardware, software, and firmware that may be used to implement the disclosed technology. System 1750 may include a processor 1755, representative of any number of physically and/or logically distinct resources capable of executing software, firmware, and hardware configured to perform identified computations. Processor 1755 may communicate with a chipset 1760 that may control input to and output from processor 1755. In this example, chipset 1760 outputs information to output 1765, such as a display, and may read and write information to storage device 1770, which may include magnetic media, and solid-state media, for example. Chipset 1760 may also read data from and write data to RAM 1775. A bridge 1780 for interfacing with a variety of user interface components 1785 may be provided for interfacing with chipset 1760. Such user interface components 1785 may include a keyboard, a microphone, touch detection and processing circuitry, a pointing device, such as a mouse, and so on. In general, inputs to system 1750 may come from any of a variety of sources, machine generated and/or human generated.

Chipset 1760 may also interface with one or more communication interfaces 1790 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1755 analyzing data stored in storage device 1770 or RAM 1775. Further, the machine may receive inputs from a user through user interface components 1785 and execute appropriate functions, such as browsing functions by interpreting these inputs using processor 1755.

It may be appreciated that example systems 1700 and 1750 may have more than one processor 1710 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for generating multi-modal response to a query using a generative machine learning model, the method comprising:
receiving, from a client device, a query data object related to a sporting event;
providing the query data object and a first prompt to a machine learning system;
receiving, from the machine learning system, a function, from a set of functions, associated with the query data object;
receiving, from the machine learning system, an output format;
providing a data source mapped to the function, the query data object, and a second prompt to the machine learning system,
receiving, from the machine learning system, a response to the query data object, wherein the response is formatted based on the output format; and
outputting the response to one or more users.

2. The method of claim 1, wherein the query data object is a query related to a player, team, graphic, video, prediction, and/or odds of the sporting event.

3. The method of claim 1, wherein the first prompt includes:
the set of functions;
a description of each function of the set of functions; and
a machine readable request instructing the machine learning system to associate the query data object with a function from the set of functions based on the description of each function.

4. The method of claim 1, wherein the first prompt includes:
a set of output formats;
a description of each output format; and
a machine readable request instructions the machine learning system to associate the query data object with the output format from the set of output formats.

5. The method of claim 4, wherein the set of output formats include graphics, audio, images, videos, image overlays, or a textual response.

6. The method of claim 1, wherein the set of functions are each mapped to respective data sources and types of information.

7. The method of claim 1, wherein the set of functions include:
a current match state function;
a current player state function;
a historical team function;
a historical player function;
a graphic function;
a video function;
a generation function;
a prediction function;
an odds function;
a other sports function; or
a non-sports question.

8. The method of claim 7, wherein if the received function, from the set of functions, is the current match state function or the current player state function, then the second prompt includes:
a machine readable request instructing the machine learning system to answer the query data object based on the current match state function or the current player state function.

9. The method of claim 7, wherein if the received function from the set of functions, is the historical team function, the historical player function, or other sports function, method further includes:
accessing a database;
requesting historical information from the database;
obtaining the historical information in a structured query language (SQL) Query; and
updating the second prompt to include a machine readable request to adapt the SQL query to extract data that responds to the query data object and form a response to the query data object.

10. The method of claim 7, wherein if the received function from the set of functions, is a non-sports question, then the method further includes:
performing a search for the query data object through an internet browser;
saving results from the internet browser; and
updating the second prompt to include a machine readable request to respond to the query data object and form a textual response based on the results from the internet browser.

11. The method of claim 7, wherein if the received function from the set of functions, is the graphic function, then the method further includes:
a machine readable request instructing the machine learning system to provide an image related to the query data object based on the graphic function.

12. The method of claim 7, wherein if the received function from the set of functions, is the generation function, then the method further includes:
sending a machine readable request instructing a second machine learning system to provide a response to the query data object based on the generation function; and
receiving the response from the second machine learning system.

13. The method of claim 1, wherein the query data object related to a sporting event includes preferences for a language, topic, style, tone, or format, the method further comprising providing the preferences to the machine learning system.

14. A system for generating textual answer to a query using a generative machine learning model, the system comprising:
a memory configured to store processor-readable instructions; and
a processor operatively connected to the memory, and configured to execute the instructions to perform operations comprising:
receiving, from a client device, a query data object related to a sporting event;
providing the query data object and a first prompt to a machine learning system;
receiving, from the machine learning system, a function, from a set of functions, associated with the query data object;
receiving, from the machine learning system, an output format;
providing a data source mapped to the function, the query data object, and a second prompt to the machine learning system,
receiving, from the machine learning system, a response to the query data object, wherein the response is formatted based on the output format; and
outputting the response to one or more users.

15. The system of claim 14, wherein the query data object is a query related to a player, team, graphic, video, prediction, and/or odds of the sporting event.

16. The system of claim 14, wherein the first prompt includes:
the set of functions;
a description of each function of the set of functions; and
a machine readable request instructing the machine learning system to associate the query data object with a function from the set of functions based on the description of each function.

17. The system of claim 14, wherein the first prompt includes:
a set of output formats;
a description of each output format; and
a machine readable request instructions the machine learning system to associate the query data object with the output format from the set of output formats.

18. A non-transitory computer readable medium configured to store processor-readable instructions, wherein when executed by a processor, the instructions perform operations comprising:
receiving, from a client device, a query data object related to a sporting event;
providing the query data object and a first prompt to a machine learning system;
receiving, from the machine learning system, a function, from a set of functions, associated with the query data object;
receiving, from the machine learning system, an output format;
providing a data source mapped to the function, the query data object, and a second prompt to the machine learning system,
receiving, from the machine learning system, a response to the query data object, wherein the response is formatted based on the output format; and
outputting the response to one or more users.

19. The non-transitory computer readable medium of claim 18, wherein the query data object is a query related to a player, team, graphic, video, prediction, and/or odds of the sporting event.

20. The non-transitory computer readable medium of claim 18, wherein the first prompt includes:
the set of functions;
a description of each function of the set of functions; and
a machine readable request instructing the machine learning system to associate the query data object with a function from the set of functions based on the description of each function.
